(19) United States
(12) Patent Application Publication
(10) Pub. No.: US 2025/0246829 A1
(43) Pub. Date: Jul. 31, 2025

(54) CONNECTOR AND CONNECTOR SET

(71) Applicant: Panasonic Intellectual Property Management Co., Ltd., Osaka (JP)

(72) Inventors: TAKASHI KOZAKI, Mie (JP); RYOSUKE SHIMOMURA, Mie (JP); YUKI MINAI, Mie (JP)

(21) Appl. No.: 19/014,460

(22) Filed: Jan. 9, 2025

(30) Foreign Application Priority Data
Jan. 26, 2024 (JP) 2024-010490

(51) Int. Cl. H01R 12/71; H01R 13/6581

(52) U.S. Cl. CPC H01R 12/716; H01R 13/6581

(57) ABSTRACT

A first predetermined terminal includes a contact part including a contact point that comes into contact with a mating predetermined terminal, a board connecting part configured to be connected to a circuit board, and a coupling part that couples the contact part and the board connecting part. The coupling part includes a separation part separated from a side wall of a shield in a front-rear direction and coupled to a rear end of the board connecting part, and a proximity part coupled to the separation part, disposed closer to the side wall of the shield than the separation part, facing the side wall of the shield via a void, and covering a part of a housing from a front side. In the front-rear direction, a distance between the side wall of the shield and the contact part is larger than a distance between the side wall of the shield and the proximity part.

### BACKGROUND

### 1. Technical Field

The present disclosure generally relates to a connector and a connector set. More specifically, the present disclosure relates to a connector connected to a mating connector, and a connector set including a connector and a mating connector.

### 2. Description of the Related Art

PTL 1 discloses a connector device including a connector and a mating connector.

The connector includes a terminal, a housing that holds the terminal, and an outer shield that surrounds the terminal. The mating connector includes a mating terminal, a housing that holds the mating terminal, and an outer shield that surrounds the mating terminal. The connector and the mating connector are connected to each other by at least one moving in an upper-lower direction toward the other.

### CITATION LIST

### Patent Literature

PTL 1: Unexamined Japanese Patent Publication No. 2021-111598

### SUMMARY

In the connector set such as the connector device described in PTL 1, it is desired to improve signal transmission performance between a predetermined terminal of the connector and a mating predetermined terminal of the mating connector.

A connector according to an aspect of the present disclosure is mounted on a circuit board and is connected to a mating connector. The connector includes a plurality of terminals, a housing, and a shield. The plurality of terminals include a predetermined terminal disposed on a foremost side in a front-rear direction. The housing holds the plurality of terminals. The shield is held by the housing. The shield surrounds the predetermined terminal. The shield has a side wall positioned in front of the predetermined terminal. The mating connector includes a plurality of mating terminals. The plurality of mating terminals include a mating predetermined terminal electrically connected to the predetermined terminal. Each of the plurality of terminals of the connector is electrically connected to one corresponding mating terminal of the plurality of mating terminals. The plurality of mating terminals include a mating predetermined terminal. The predetermined terminal includes a contact part, a board connecting part, and a coupling part. The contact part includes a contact point that comes into contact with the mating predetermined terminal. The board connecting part is configured to be connected to the circuit board. The coupling part couples the contact part and the board connecting part. The coupling part includes a separation part and a proximity part. The separation part is separated from the side wall of the shield in the front-rear direction. The separation part is coupled to a rear end of the board connecting part. The proximity part is coupled to the separation part. The proximity part is disposed closer to the side wall of the shield than the separation part. The proximity part faces the side wall of the shield via a void. The proximity part covers a part of the housing from a front side. A distance between the side wall of the shield and the contact part is longer than a distance between the side wall of the shield and the proximity part in the front-rear direction.

A connector according to another aspect of the present disclosure is connected to a mating connector. The connector includes a predetermined terminal and a housing. The housing holds the predetermined terminal. The mating connector includes a mating predetermined terminal electrically connected to the predetermined terminal. The predetermined terminal includes a first contact part, a second contact part, a board connecting part, and a coupling part. The first contact part includes a first contact point that comes into contact with the mating predetermined terminal. The second contact part includes a second contact point that comes into contact with the mating predetermined terminal. The board connecting part is configured to be connected to a circuit board. The coupling part couples the first contact part, the second contact part, and the board connecting part. The coupling part is configured to be elastically deformable such that the first contact part moves in the left-right direction in which the first contact part and the second contact part are aligned. The second contact part is fixed to the housing. The first contact point is disposed on a surface of the first contact part opposite to a facing surface facing the second contact part. The second contact point is disposed on a surface of the second contact part opposite to a facing surface facing the first contact part.

A connector set according to still another aspect of the present disclosure includes the connector and the mating connector. The mating predetermined terminal includes a first mating contact part, a second mating contact part, a mating board connecting part, and a mating coupling part. The first mating contact part is fixed to the mating housing. The first mating contact part comes into contact with the first contact part. The second mating contact part is fixed to the mating housing. The second mating contact part comes into contact with the second contact part. The mating board connecting part is configured to be connected to a mating circuit board. The mating coupling part couples the first mating contact part, the second mating contact part, and the mating board connecting part. In a state where the connector and the mating connector are connected, the first contact part and the second contact part of the connector are disposed between the first mating contact part and the second mating contact part.

According to the present disclosure, there is an advantage that signal transmission performance can be improved.

### BRIEF DESCRIPTION OF THE DRAWINGS

FIG. 1 is a perspective view of a connector set according to an exemplary embodiment of the present disclosure in a connected state where a connector and a mating connector are connected as viewed from above;

FIG. 2 is a perspective view of the connector set in a disconnected state where the connector and the mating connector are separated as viewed from above;

FIG. 3 is an exploded perspective view of the connector as viewed from above;

FIG. 4 is a top view of the connector;

FIG. 5 is a perspective view of a first predetermined terminal, a second predetermined terminal, and a guard included in the connector as viewed from above;

FIG. 6 is a bottom view of the connector;

FIG. 7 is a perspective view of the mating connector as viewed from below;

FIG. 8 is an exploded perspective view of the mating connector as viewed from below;

FIG. 9 is a bottom view of the mating connector;

FIG. 10 is a top view of the mating connector;

FIG. 11 is a top view of the connector set in a connected state;

FIG. 12 is a sectional view of a portion corresponding to line XIII-XIII of FIG. 11 in a disconnected state of the connector set;

FIG. 13 is a sectional view taken along a line XIII-XIII in FIG. 11 in the connected state of the connector set;

FIG. 14 is a sectional view of a portion corresponding to line XIV-XIV in FIG. 11 in the connected state of the connector set in which a housing and a mating housing are omitted;

FIG. 15 is a sectional view of a portion corresponding to line XVI-XVI in FIG. 11 in the disconnected state of the connector set;

FIG. 16 is a sectional view taken along line XVI-XVI of FIG. 11 in the connected state of the connector set;

FIG. 17 is a sectional view of a portion corresponding to line XVIII-XVIII in FIG. 11 in a disconnected state of the connector set;

FIG. 18 is a sectional view taken along a line XVIII-XVIII in FIG. 11 in the connected state of the connector set;

FIG. 19 is a sectional view of a portion corresponding to line XX-XX in FIG. 11 in the disconnected state of the connector set;

FIG. 20 is a sectional view taken along line XX-XX of FIG. 11 in the connected state of the connector set;

FIG. 21 is a sectional view of a portion corresponding to line XIII-XIII in FIG. 11 in a state where the mating connector is inclined with respect to the connector in the connector set;

FIG. 22 is a sectional view of a portion corresponding to line XVIII-XVIII in FIG. 11 in a state where the mating connector is inclined with respect to the connector in the connector set; and

FIG. 23 is a sectional view of the connector set in a state where the mating connector is inclined with respect to the connector.

### DETAILED DESCRIPTIONS

Hereinafter, a connector, a mating connector, and a connector set according to an exemplary embodiment of the present disclosure will be described with reference to the accompanying drawings. The following exemplary embodiment is merely one of various exemplary embodiments of the present disclosure. The following exemplary embodiment can be variously changed in accordance with factors such as a design, as long as the object of the present disclosure can be achieved. The drawings described in the following exemplary embodiment are schematic representations, and ratios of sizes and thicknesses of components in the drawings do not necessarily need to reflect actual dimensional ratio.

### (1) Exemplary Embodiment

### (1.1) Overview of Connector Set

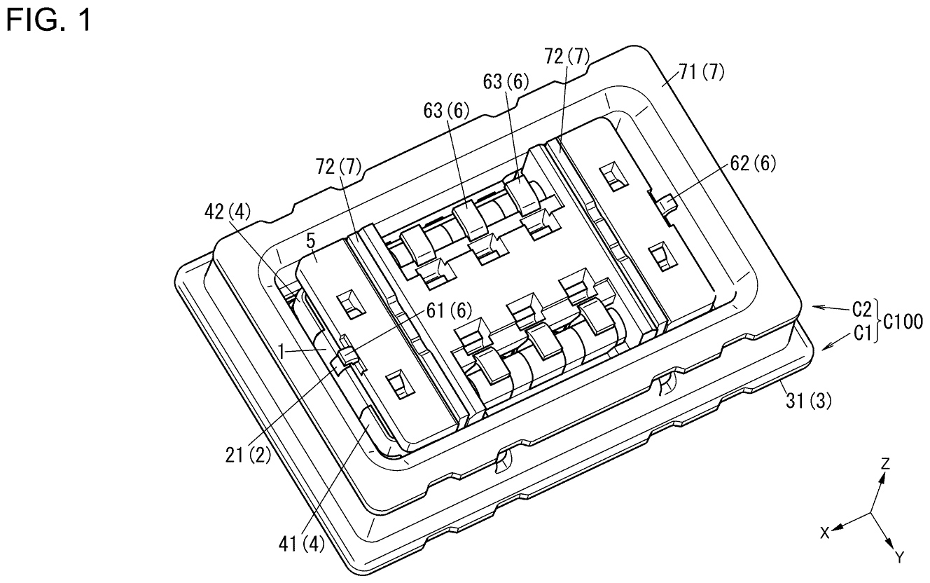

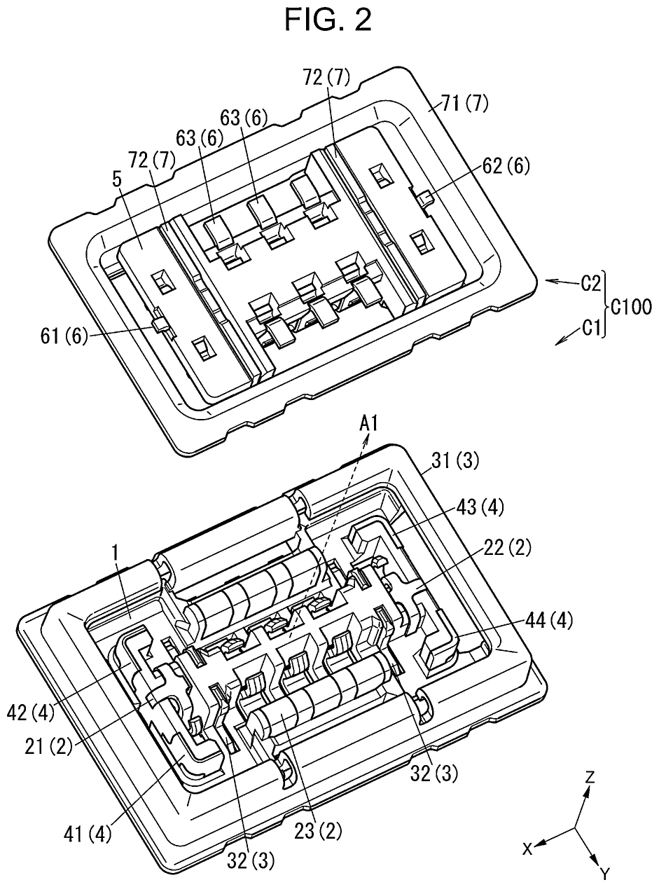

As illustrated in FIGS. 1 and 2, connector set C100 of the present exemplary embodiment includes connector C1 (socket) and mating connector C2 (header) connected to connector C1.

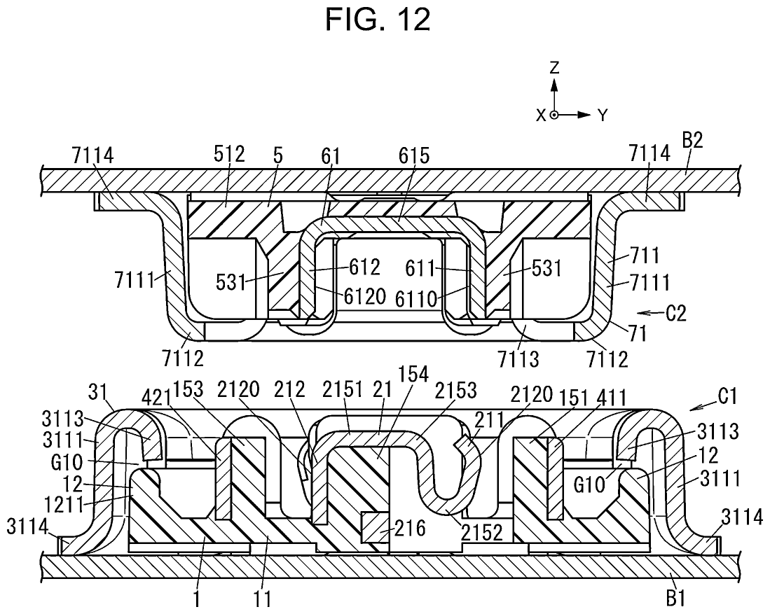

Connector set C100 is used, for example, to electrically connect a plurality of boards together incorporated in a mobile terminal such as a smartphone. Connector C1 is attached to circuit board B1 (see FIGS. 12, 13, and 15 to 20). Mating connector C2 is attached to mating circuit board B2 (see FIGS. 12, 13, and 15 to 20). Connector set C100 mechanically and electrically connects circuit board B1 and mating circuit board B2 by connecting connector C1 and mating connector C2 to each other. Connector set C100 may be used for an electronic device other than the mobile terminal, such as a camera module. Connector set C100 may be used to electrically connect a plurality of components together, such as a board and a display, and a board and a battery, other than electrically connecting the plurality of boards together.

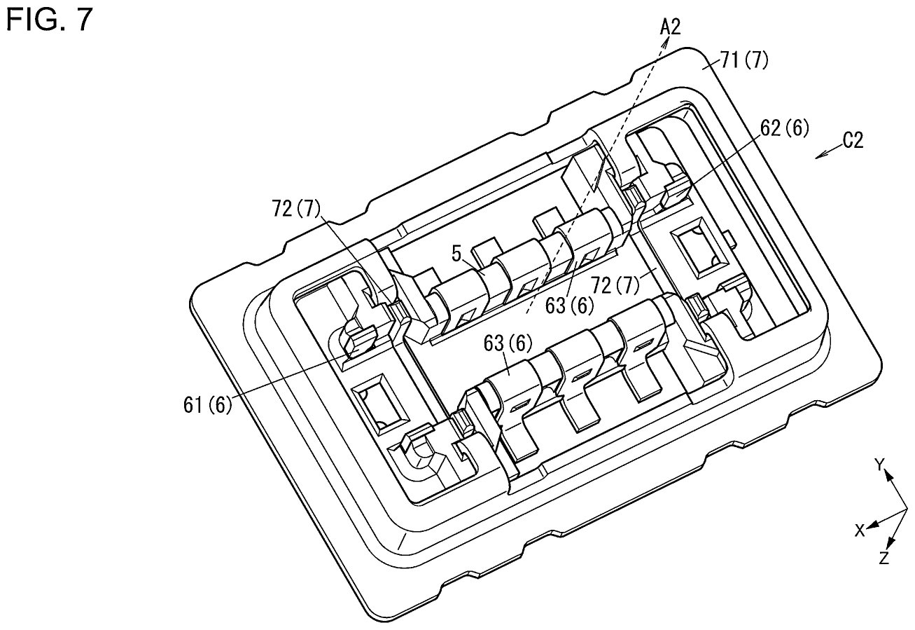

As illustrated in FIG. 2, connector C1 has a substantially rectangular parallelepiped shape having a width, a length, and a thickness. As illustrated in FIG. 7, mating connector C2 has a substantially rectangular parallelepiped shape having a width, a length, and a thickness. As illustrated in FIG. 2, connector C1 is connected to mating connector C2 from one side in one direction. In a connected state where connector C1 and mating connector C2 are connected (see FIG. 1), connector set C100 has a substantially rectangular parallelepiped shape having a width, a length, and a thickness.

Hereinafter, for the sake of convenience, in the connected state illustrated in FIG. 1, three axes (X-axis, Y-axis, and Z-axis) of a right-handed three-dimensional orthogonal coordinate system will be defined and described as follows with respect to connector set C100. That is, a direction along the thickness of connector set C100 that is a direction in which connector C1 and mating connector C2 face each other when connector C1 and mating connector C2 are connected is defined as a Z-axis direction. A direction orthogonal to the Z-axis direction and along the length of connector set C100 is defined as an X-axis direction. A direction orthogonal to both the X-axis direction and the Z-axis direction and along the width of connector set C100 is defined as a Y-axis direction. For the sake of convenience in description, the Z-axis direction is defined as an upper-lower direction, a side where mating connector C2 is positioned with respect to connector C1 (positive orientation of the Z-axis) is defined as “upper”, and the opposite orientation is defined as “lower”. The X-axis direction is defined as a front-rear direction, a positive orientation of the X-axis is defined as “front”, and the opposite orientation is defined as “rear”. The Y-axis direction is defined as a left-right direction, a positive orientation of the Y-axis is defined as “left”, and the opposite orientation is defined as “right”. However, the definition of the axis and direction in the present disclosure merely indicates a relative positional relationship between the members of connector set C100, and does not limit the orientation of connector set C100 at the time of use or the like. A dimension of connector set C100 in the front-rear direction (length direction) in the connected state is, for example, about several [mm].

### (1.2) Connector

As illustrated in FIGS. 2 to 6, connector C1 includes housing 1, a plurality of terminals 2, shield 3, and guard 4.

### (1.2.1) Housing

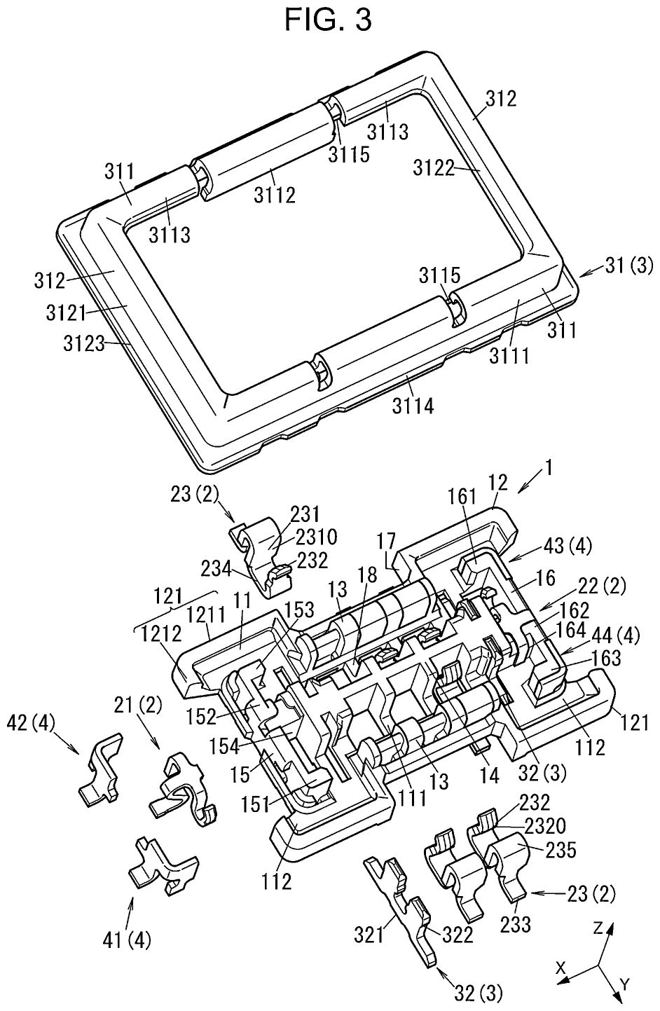

Housing 1 is made of an insulating resin material and is formed in a substantially flat rectangular parallelepiped shape long in the front-rear direction as illustrated in FIG. 3. Housing 1 has a two-fold rotationally symmetric shape around axis A1 (see FIG. 2) that passes through a center of housing 1 and is along the upper-lower direction. Housing 1 holds the plurality of terminals 2, shield 3, and guard 4.

As illustrated in FIG. 3, housing 1 integrally includes bottom wall 11, outer wall 12, a pair of side wall parts 13, central wall part 14, one end wall part (hereinafter, also referred to as “first end wall part”) 15, and another end wall part (hereinafter, also referred to as “second end wall part”) 16.

Bottom wall 11 has a plate shape whose thickness direction is along the upper-lower direction. Bottom wall 11 integrally includes inner bottom wall 111 and a pair of outer bottom walls 112.

Inner bottom wall 111 has a rectangular plate shape as viewed from above.

The pair of outer bottom walls 112 is connected to both front and rear ends of inner bottom wall 111. Each of the pair of outer bottom walls 112 has a rectangular shape as viewed from above, and has a plate shape whose dimension in the left-right direction is larger than a dimension of inner bottom wall 111. A center of the front end of outer bottom wall 112 on a front side is recessed rearward. A center of the rear end of outer bottom wall 112 on a rear side is recessed forward.

On left and right side surfaces of bottom wall 11, there is a step at a joint portion between inner bottom wall 111 and outer bottom wall 112. As a result, housing 1 has notch 17 at a center in the front-rear direction on both left and right side surfaces, and is formed in an H shape in top view.

Outer wall 12 protrudes upward from bottom wall 11. Outer wall 12 is provided at peripheral portions of the pair of outer bottom walls 112. Outer wall 12 has four partial wall parts 121 provided on four sides of bottom wall 11. Each partial wall part 121 integrally includes first portion 1211 extending along a long side of bottom wall 11 (side along the front-rear direction) and second portion 1212 extending along a short side of bottom wall 11 (side along the left-right direction).

The pair of side wall parts 13 protrudes upward from bottom wall 11. The pair of side wall parts 13 is provided at peripheral portions (left edge and right edge) of inner bottom wall 111. Side wall part 13 has a wall shape long in the front-rear direction.

Central wall part 14 protrudes upward from bottom wall 11. Central wall part 14 has an island wall shape long in the front-rear direction. Central wall part 14 is formed between the pair of side wall parts 13 on an upper surface of bottom wall 11. A pair of recesses 18 is formed along the front-rear direction between the pair of side wall parts 13 and central wall part 14. Note that the pair of side wall parts 13 may be (partially) connected to central wall part 14.

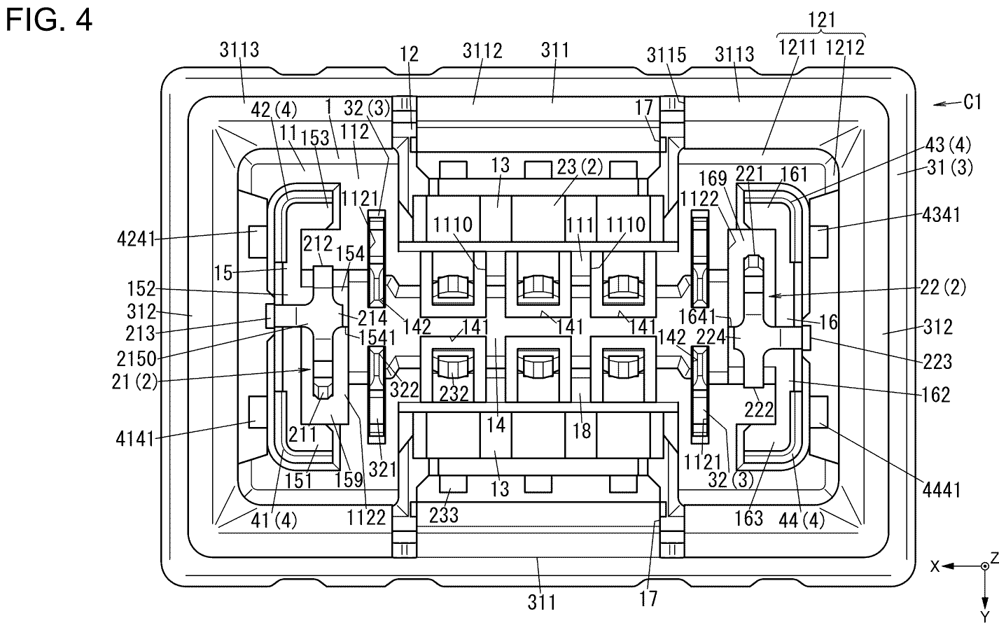

As illustrated in FIG. 4, a plurality of dents 141 (here, a total of six dents of three dents on a left side surface and three dents on a right side surface) are provided to be aligned in the front-rear direction on left and right side surfaces of central wall part 14. In inner bottom wall 111, a plurality of (here, six) through-holes 1110 penetrating vertically are formed to be connected to the plurality of dents 141 of central wall part 14.

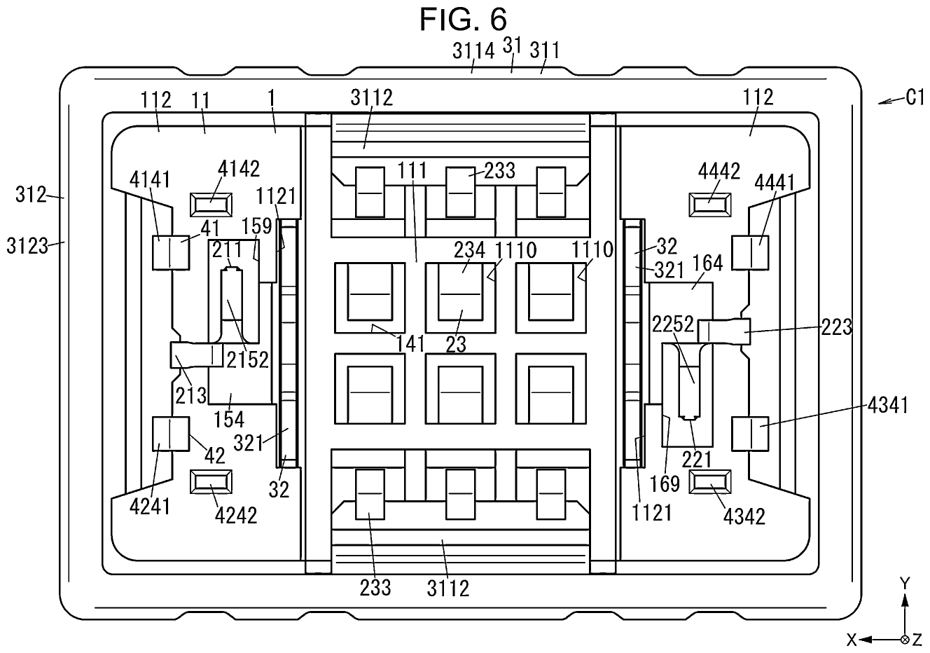

A pair of accommodation grooves 142 is formed on left and right side surfaces of a front end part and a rear end part of central wall part 14 (portions of central wall part 14 provided on outer bottom wall 112). As illustrated in FIGS. 4 and 6, an accommodation hole 1121 long in the left-right direction is formed in a lower surface of outer bottom wall 112 to be connected to the pair of left and right accommodation grooves 142 of central wall part 14.

As illustrated in FIGS. 3 and 4, first end wall part 15 protrudes upward from bottom wall 11. First end wall part 15 protrudes upward in an island shape from outer bottom wall 112 on the front side, of the pair of outer bottom walls 112. First end wall part 15 is provided at a front end of a central portion of outer bottom wall 112 on the front side in the left-right direction.

First end wall part 15 has an E shape as viewed from above. More specifically, first end wall part 15 includes first partition wall 151, second partition wall 152, third partition wall 153, and coupling wall 154. Second partition wall 152 has a wall shape extending in the left-right direction along the front end of outer bottom wall 112 on the front side. Coupling wall 154 connects a central portion of a rear surface of second partition wall 152 in the left-right direction and a front end of central wall part 14. First partition wall 151 has a wall shape extending rearward from a left end of second partition wall 152. Third partition wall 153 has a wall shape extending rearward from a right end of second partition wall 152. That is, a front end of first partition wall 151 is connected to one end (left end) of second partition wall 152 in the left-right direction, and a front end of third partition wall 153 is connected to one end (right end) of second partition wall 152 in the left-right direction. First partition wall 151 and second partition wall 152 are disposed in an L shape as viewed from above. Third partition wall 153 and second partition wall 152 are disposed in an L shape as viewed from above. First partition wall 151 is disposed between first portion 1211 of partial wall part 121 on a left front side of outer wall 12 and coupling wall 154 in the left-right direction. Third partition wall 153 is disposed between first portion 1211 of partial wall part 121 on a right front side of outer wall 12 and coupling wall 154 (here, substantially intermediate) in the left-right direction.

Dent 1541 is formed on a left side surface of coupling wall 154 to be recessed rightward. Through-hole 1122 vertically penetrating is formed in outer bottom wall 112 on the front side to be connected to dent 1541 of coupling wall 154. Space 159 having a rectangular shape as viewed from above is formed in housing 1 by dent 1541 of coupling wall 154 and through-hole 1122 of outer bottom wall 112. Note that coupling wall 154 may not be connected to central wall part 14. That is, first end wall part 15 may be separated from central wall part 14 with bottom wall 11 interposed therebetween.

As illustrated in FIGS. 3 and 4, second end wall part 16 protrudes upward from bottom wall 11. Second end wall part 16 protrudes upward from outer bottom wall 112 on the rear side, of the pair of outer bottom walls 112. Second end wall part 16 is provided at a rear end of a central portion in the left-right direction of outer bottom wall 112 on the rear side. Second end wall part 16 has a two-fold rotationally symmetric shape with first end wall part 15 around axis A1. Thus, a detailed description of second end wall part 16 is omitted. Note that second end wall part 16 includes first partition wall 161, second partition wall 162, third partition wall 163, and coupling wall 164 to correspond to first partition wall 151, second partition wall 152, third partition wall 153, and coupling wall 154 of first end wall part 15, respectively. Dent 1641 recessed leftward is provided on a right side surface of coupling wall 164 to be connected to through-hole 1122 formed in outer bottom wall 112 on the rear side. Space 169 having a rectangular shape as viewed from above is formed in housing 1 by dent 1641 of coupling wall 164 and through-hole 1122 of outer bottom wall 112.

### (1.2.2) Terminal

As illustrated in FIGS. 2 to 6, connector C1 includes a plurality of (here, eight) terminals 2. Terminal 2 is made of metal. The plurality of terminals 2 are held by housing 1. The plurality of terminals 2 are electrically connected to a plurality of mating terminals 6 included in mating connector C2 in a connected state where connector C1 and mating connector C2 are connected.

Here, the plurality of terminals 2 include first predetermined terminal 21, second predetermined terminal 22, and a plurality of (here, six) connection terminals 23. First predetermined terminal 21 and second predetermined terminal 22 are, for example, high frequency terminals for transmitting relatively high frequency signals. The plurality of connection terminals 23 are, for example, low frequency terminals for transmitting relatively low frequency signals to predetermined terminals 21 and 22. The plurality of connection terminals 23 may include a power supply terminal.

### (1.2.2.1) Predetermined Terminal

First predetermined terminal 21 is disposed on a foremost side in the front-rear direction, among the plurality of terminals 2. First predetermined terminal 21 is held by first end wall part 15 of housing 1.

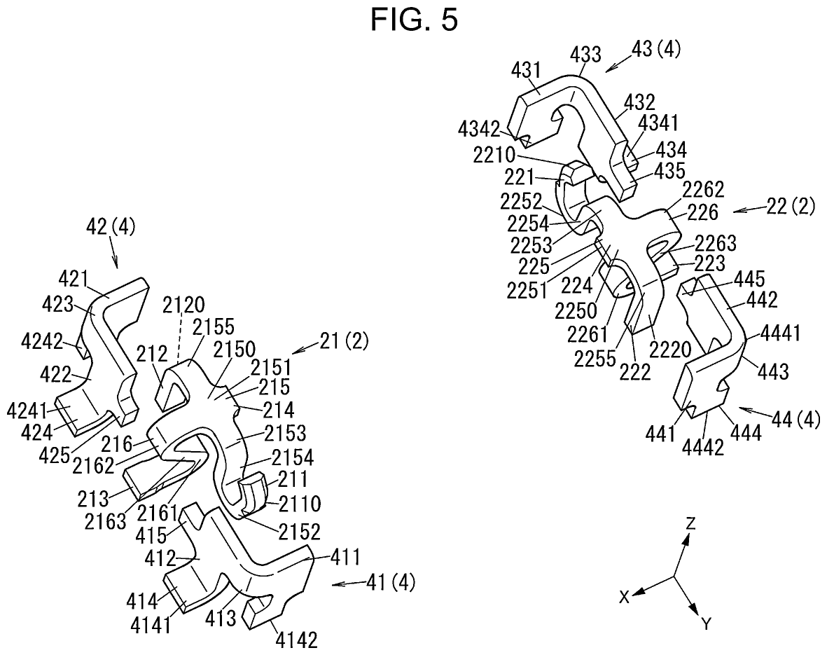

As illustrated in FIG. 5, first predetermined terminal 21 integrally includes first contact part 211, second contact part 212, board connecting part 213, and coupling part 214.

First contact part 211 and second contact part 212 are portions of first predetermined terminal 21 that come into contact with first mating predetermined terminal 61 of mating connector C2 in the connected state where connector C1 and mating connector C2 are connected. First contact part 211 includes first contact point 2110 that comes into contact with first mating predetermined terminal 61. Second contact part 212 includes second contact point 2120 that comes into contact with first mating predetermined terminal 61. As described above, the contact parts (first contact part 211 and second contact part 212) include contact points (first contact point 2110 and second contact point 2120) that come into contact with first mating predetermined terminal 61. First contact part 211 and second contact part 212 are disposed to be aligned in the left-right direction.

First contact part 211 has a plate shape whose thickness direction is along the left-right direction. A central portion of first contact part 211 is thicker than both ends (front end and rear end) in a width direction (front-rear direction). First contact part 211 is curved in a C shape to protrude leftward. First contact point 2110 includes a portion of first contact part 211 protruding leftward. First contact point 2110 is formed on a surface (left surface) of first contact part 211 opposite to a facing surface (right surface) facing second contact part 212.

Second contact part 212 has a plate shape whose thickness direction is along the left-right direction. Second contact part 212 has a flat plate shape. Second contact point 2120 includes a right surface (plane) of second contact part 212. That is, second contact point 2120 is formed on a surface (right surface) of second contact part 212 opposite to a facing surface (left surface) facing first contact part 211.

Board connecting part 213 is configured to be connected to circuit board B1. Board connecting part 213 has a plate shape whose thickness direction is along the upper-lower direction. Board connecting part 213 has a flat plate shape. Board connecting part 213 is fixed and electrically connected to a pad of circuit board B1 by, for example, soldering or the like.

Coupling part 214 couples the contact parts (first contact part 211 and second contact part 212) and board connecting part 213. Coupling part 214 couples first contact part 211, second contact part 212, and board connecting part 213. Note that the contact part may be at least one of first contact part 211 and second contact part 212.

As illustrated in FIG. 5, coupling part 214 includes first coupling part 215 and second coupling part 216.

First coupling part 215 couples first contact part 211 and second contact part 212. As illustrated in FIG. 5, first coupling part 215 includes flat part 2151 and curved part (first curved part) 2152. First coupling part 215 further includes second curved part 2153, connecting part 2154, and third curved part 2155.

Flat part 2151 has a plate shape whose thickness direction is along the upper-lower direction. Flat part 2151 has a flat plate shape. An upper surface of flat part 2151 is flat face 2150 extending in the left-right direction. As described above, flat part 2151 includes flat face 2150 extending in the left-right direction. A thickness direction of flat part 2151 intersects (is orthogonal to) a thickness direction of second contact part 212.

Flat part 2151 is coupled to first contact part 211 and second contact part 212. First contact part 211 is coupled to a left end of flat part 2151, and second contact part 212 is coupled to a right end of flat part 2151. More specifically, the left end of flat part 2151 is coupled to a lower end of first contact part 211 via second curved part 2153 curved in an R shape, connecting part 2154, and first curved part 2152. The right end of flat part 2151 is coupled to an upper end of second contact part 212 via third curved part 2155 curved in an R shape.

Connecting part 2154 has a plate shape extending vertically. An upper end of connecting part 2154 is coupled to the left end of flat part 2151 via second curved part 2153 curved in an R shape. A lower end of connecting part 2154 is coupled to a first end (upper right end) of first curved part 2152.

First curved part 2152 has a U-shaped plate shape. First curved part 2152 is coupled to first contact part 211 and is curved to protrude downward. The first end of first curved part 2152 is coupled to the lower end of connecting part 2154. A second end (upper left end) of first curved part 2152 is coupled to the lower end of first contact part 211. First curved part 2152 has the U shape, and thus, the dimension in the left-right direction can be reduced. As a result, an elastic return force to return to an original shape when first curved part 2152 is elastically deformed is improved.

First curved part 2152 is elastically deformed, and thus, first contact part 211 is movable in the left-right direction with respect to flat part 2151. First contact part 211 is movable in the left-right direction with respect to flat part 2151 even though second curved part 2153 is elastically deformed. That is, first coupling part 215 is elastically deformable at two points of first curved part 2152 and second curved part 2153. As a result, as compared with a structure in which the first coupling part is elastically deformed at one point, an elastic return force to return to an original shape when first coupling part 215 is elastically deformed is improved. First coupling part 215 is less likely to be plastically deformed.

Second coupling part 216 couples first coupling part 215 and board connecting part 213. As described above, second coupling part 216 couples the contact parts (first contact part 211 and second contact part 212) and board connecting part 213. Second coupling part 216 is coupled to a front end of flat part 2151.

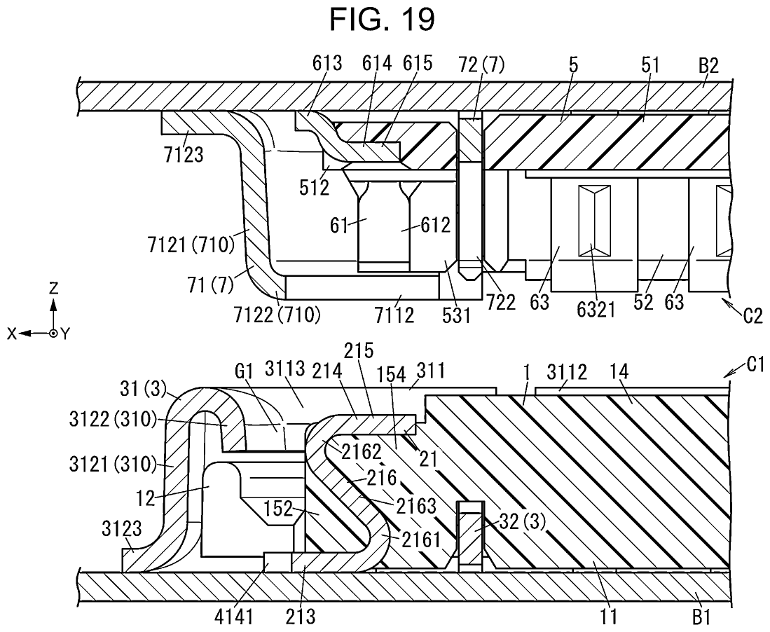

As illustrated in FIG. 5, second coupling part 216 includes two curved parts and intermediate part 2163 coupling the two curved parts. As illustrated in FIG. 19, one of the two curved parts of second coupling part 216 is relatively separated from side wall 310 of shield 3 (outer wall 3121 and extension part 3122 of outer shield 31) in the front-rear direction, and the other of the two curved parts of second coupling part 216 is relatively disposed closer to side wall 310 of shield 3 in the front-rear direction. Thus, in the following description, for the sake of convenience, one of the two curved parts of second coupling part 216 relatively separated from side wall 310 of shield 3 is referred to as “separation part 2161”, and the other relatively closer to side wall 310 of shield 3 is referred to as “proximity part 2162”.

Separation part 2161 is separated from side wall 310 of shield 3 in the front-rear direction. Separation part 2161 is coupled to a rear end of board connecting part 213. Separation part 2161 is curved upward in an R shape from the rear end of board connecting part 213 and extends obliquely forward. First predetermined terminal 21 has separation part 2161, and thus, a capacitance of an electric path including first predetermined terminal 21 with respect to a ground (second outer shield 312) can be reduced. As a result, it is possible to improve signal transmission performance in a case where a high-frequency signal is transmitted via the electric path including first predetermined terminal 21.

Proximity part 2162 is disposed closer to side wall 310 of shield 3 than separation part 2161. However, proximity part 2162 does not come into contact with side wall 310 of shield 3 and faces side wall 310 of shield 3 via void G1 (see FIG. 19). Proximity part 2162 is coupled to the front end of flat part 2151 of first coupling part 215. Proximity part 2162 is curved downward in an R shape from the front end of flat part 2151 and extends obliquely rearward.

As illustrated in FIG. 5, proximity part 2162 is positioned in front of the contact parts (first contact part 211 and second contact part 212). Thus, in the front-rear direction, a distance between side wall 310 of shield 3 and the contact part is larger than a distance between side wall 310 of shield 3 and proximity part 2162.

Intermediate part 2163 couples separation part 2161 and proximity part 2162. Intermediate part 2163 has a plate shape, and here, has a flat plate shape. Intermediate part 2163 extends obliquely forward and upward from separation part 2161 and is coupled to proximity part 2162. Thus, a length of a conduction path between separation part 2161 and proximity part 2162 can be minimized. As a result, signal transmission performance is improved in a case where a high-frequency signal is transmitted via the electric path including first predetermined terminal 21. A thickness direction of intermediate part 2163 intersects the thickness direction of flat part 2151 without being orthogonal thereto. The thickness direction of intermediate part 2163 intersects a thickness direction of board connecting part 213 without being orthogonal thereto. A portion including flat part 2151, second coupling part 216, and board connecting part 213 is formed in an S shape (or a Z shape) as viewed from a side (one side in the left-right direction).

As illustrated in FIG. 5, second coupling part 216 is positioned between first contact part 211 and second contact part 212 in the left-right direction as viewed from the front-rear direction. A distance between second coupling part 216 and first contact part 211 is larger than a distance between second coupling part 216 and second contact part 212 in the left-right direction as viewed in the front-rear direction. As a result, an elastic force of the curved portions (first curved part 2152 and second curved part 2153) coupling first contact part 211 and second coupling part 216 is improved.

As described above, second coupling part 216 couples first coupling part 215 and board connecting part 213. Thus, separation part 2161, proximity part 2162, and intermediate part 2163 of second coupling part 216 constitute a conduction path between board connecting part 213 and the contact part (first contact part 211 and second contact part 212). In particular, intermediate part 2163 constituting the conduction path between separation part 2161 and proximity part 2162 obliquely couples separation part 2161 and proximity part 2162, and thus, a length of the conduction path can be minimized.

As illustrated in FIGS. 2 to 4, first predetermined terminal 21 is held by first end wall part 15 of housing 1.

Flat part 2151 is fixed to housing 1. Flat part 2151 is partially buried in coupling wall 154 of first end wall part 15 such that flat face 2150 as the upper surface is exposed upward from housing 1. The upper surface (flat face 2150) of flat part 2151 is above an upper surface of coupling wall 154 of first end wall part 15. Flat face 2150 is exposed upward, and thus, a probe can be brought into contact with flat face 2150 from an outside. As a result, in a case where first predetermined terminal 21 is fixed to circuit board B1 by soldering or the like, conduction between first predetermined terminal 21 and circuit board B1 can be easily confirmed.

As illustrated in FIG. 4, the left end of flat part 2151 protrudes from coupling wall 154 to space 159 of housing 1. Second curved part 2153, connecting part 2154, first curved part 2152, and first contact part 211 are disposed in space 159. Thus, first coupling part 215 is elastically deformable in the left-right direction in space 159, and first contact part 211 is movable in the left-right direction in space 159. As described above, (first coupling part 215 of) coupling part 214 is configured to be elastically deformable such that first contact part 211 moves in the left-right direction in which first contact part 211 and second contact part 212 are aligned.

As illustrated in FIG. 4, second contact part 212 is fixed to housing 1. Second contact part 212 is partially buried in coupling wall 154 of first end wall part 15 such that a right surface including second contact point 2120 is exposed rightward from coupling wall 154. The right surface of second contact part 212 is on a right side of a right surface of coupling wall 154 of first end wall part 15.

Proximity part 2162 is fixed to housing 1. As illustrated in FIG. 19, proximity part 2162 is partially buried in second partition wall 152 of first end wall part 15 such that an upper surface and a front end surface of proximity part 2162 are exposed from housing 1. The upper surface of proximity part 2162 is above an upper surface of second partition wall 152 of first end wall part 15. In the front-rear direction, a front end of proximity part 2162 is at the same position as a front surface of second partition wall 152 of first end wall part 15. It can be said that proximity part 2162 covers (partially) second partition wall 152 of housing 1 from a front side.

Separation part 2161 is fixed to housing 1. As illustrated in FIG. 19, separation part 2161 is buried in housing 1. Here, entire separation part 2161 is buried in coupling wall 154 of first end wall part 15. Separation part 2161 is buried in housing 1, and thus, deformation of first predetermined terminal 21 (separation part 2161) is prevented.

Intermediate part 2163 is fixed to housing 1. As illustrated in FIG. 19, intermediate part 2163 is buried in housing 1. Here, entire intermediate part 2163 is buried in first end wall part 15. Intermediate part 2163 is buried in housing 1, and thus, deformation of the first predetermined terminal (intermediate part 2163) is prevented.

As illustrated in FIG. 6, a lower surface of board connecting part 213 is exposed from housing 1. As illustrated in FIG. 19, the lower surface of board connecting part 213 is at the same position as a lower surface of housing 1 or below the lower surface of housing 1 in the upper-lower direction (in the present exemplary embodiment, on a lower side). A front end of board connecting part 213 protrudes forward from the front end of outer bottom wall 112 on the front side of housing 1.

As illustrated in FIG. 4, second predetermined terminal 22 is disposed rearmost in the front-rear direction, among the plurality of terminals 2. Second predetermined terminal 22 is held by second end wall part 16 of housing 1.

As illustrated in FIG. 5, second predetermined terminal 22 has a shape obtained by rotating first predetermined terminal 21 by 180 degrees around axis A1 (see FIG. 2) set in housing 1. Thus, a detailed description of second predetermined terminal 22 is omitted. Note that second predetermined terminal 22 includes first contact part 221, second contact part 222, board connecting part 223, and coupling part 224 to correspond to first contact part 211, second contact part 212, board connecting part 213, and coupling part 214 of first predetermined terminal 21, respectively. First contact part 221 includes first contact point 2210, and second contact part 222 includes second contact point 2220. Coupling part 224 includes first coupling part 225 and second coupling part 226. First coupling part 225 includes flat part 2251 having flat face 2250, curved part (first curved part 2252), second curved part 2253, connecting part 2254, and third curved part 2255. Second coupling part 226 has separation part 2261, proximity part 2262, and intermediate part 2263.

### (1.2.2.2) Connection Terminal

As illustrated in FIGS. 2 to 4 and 6, the plurality of connection terminals 23 are disposed between first predetermined terminal 21 and second predetermined terminal 22 in the front-rear direction. The plurality of connection terminals 23 are held by the pair of side wall parts 13 of housing 1. Here, six connection terminals 23 are held to be aligned in the front-rear direction, three each on the pair of side wall parts 13.

As illustrated in FIG. 3, each connection terminal 23 integrally includes third contact part 231, fourth contact part 232, board connecting part 233, first coupling part 234, and second coupling part 235.

Third contact part 231 and fourth contact part 232 are portions of connection terminal 23 that come into contact with mating connection terminal 63 of mating connector C2 in the connected state where connector C1 and mating connector C2 are connected. Third contact part 231 includes third contact point 2310 that comes into contact with mating connection terminal 63. Fourth contact part 232 includes fourth contact point 2320 that comes into contact with mating connection terminal 63. Third contact part 231 and fourth contact part 232 are disposed to be aligned in the left-right direction.

Third contact part 231 has a plate shape whose thickness direction is along the left-right direction. Third contact part 231 has a flat plate shape. Third contact point 2310 is formed on a facing surface of third contact part 231 facing fourth contact part 232.

Fourth contact part 232 has a plate shape whose thickness direction is along the left-right direction. Fourth contact part 232 is curved in a C shape to protrude toward third contact part 231. Fourth contact part 232 faces third contact part 231. Fourth contact point 2320 includes a portion of fourth contact part 232 protruding toward third contact part 231. Fourth contact point 2320 is formed on a facing surface of fourth contact part 232 facing third contact part 231.

Board connecting part 233 is configured to be connected to circuit board B1. Board connecting part 233 has a plate shape whose thickness direction is along the upper-lower direction. Board connecting part 233 has a flat plate shape. Board connecting part 233 is fixed and electrically connected to the pad of circuit board B1 by, for example, soldering or the like.

First coupling part 234 couples third contact part 231 and fourth contact part 232. First coupling part 234 has a U-shaped plate shape coupling a lower end of third contact part 231 and a lower end of fourth contact part 232.

Second coupling part 235 couples third contact part 231 and board connecting part 233. Second coupling part 235 has a J-shaped plate shape coupling an upper end of third contact part 231 and board connecting part 233.

Connection terminal 23 is fixed to housing 1. Connection terminal 23 is held by housing 1 in a state where a part of first coupling part 234 (a portion coupled to third contact part 231) and a part of second coupling part 235 (a lower end part) are buried in side wall part 13.

Third contact part 231 is fixed to housing 1. On the other hand, fourth contact part 232 is disposed in recess 18 of housing 1 and is movable in the left-right direction in recess 18 (in particular, in a space including through-hole 1110).

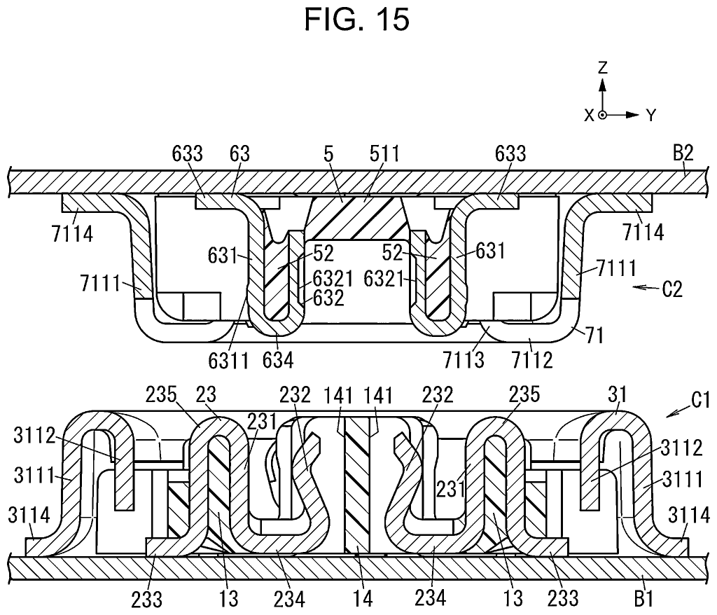

As illustrated in FIG. 6, a lower surface of board connecting part 233 is exposed from housing 1. As illustrated in FIG. 15, the lower surface of board connecting part 233 is at the same position as the lower surface of housing 1 or below the lower surface of housing 1 in the upper-lower direction (in the present exemplary embodiment, on a lower side). The lower surface of board connecting part 233 is at the same position as the lower surface of board connecting part 213 of first predetermined terminal 21 and the lower surface of the board connecting part 223 of second predetermined terminal 22 in the upper-lower direction. As illustrated in FIGS. 3 and 4, board connecting part 233 protrudes outward in the left-right direction from inner bottom wall 111 of housing 1.

### (1.2.3) Shield

As illustrated in FIGS. 2 to 4 and 6, shield 3 includes outer shield 31 and inner shield 32.

### (1.2.3.1) Outer Shield

Outer shield 31 contains metal as a main material or a material such as plating constituting a surface. Here, as an example, outer shield 31 is formed by using metal as a main material.

As illustrated in FIGS. 3 and 4, outer shield 31 integrally includes a pair of first outer shields 311 and a pair of second outer shields 312.

As illustrated in FIGS. 3 and 4, the pair of first outer shields 311 is formed to be long in the front-rear direction on a left side and a right side of housing 1. The pair of first outer shields 311 is disposed to face each other in the left-right direction. First predetermined terminal 21, second predetermined terminal 22, and the plurality of connection terminals 23 are disposed between the pair of first outer shields 311. As described above, the pair of first outer shields 311 is disposed to face each other in the left-right direction with first predetermined terminal 21 and second predetermined terminal 22 interposed therebetween.

As illustrated in FIG. 3, first outer shield 311 includes outer wall 3111, first extension part 3112, a pair of second extension parts 3113, and flange 3114.

Outer wall 3111 has a wall shape facing entire housing 1 in the front-rear direction. Outer wall 3111 is disposed outward with respect to outer wall 12 (more specifically, first portion 1211 of partial wall part 121) of housing 1 in the left-right direction.

First extension part 3112 is curved inward and extends downward from an upper end of a central portion of outer wall 3111 in the front-rear direction. First extension part 3112 is formed to face side wall part 13 over the entire length of side wall part 13 of housing 1 in the front-rear direction. First extension part 3112 faces side wall part 13 of housing 1 in the left-right direction.

Both ends of first extension parts 3112 of the pair of first outer shields 311 in the front-rear direction are press-fitted into the pair of notches 17 (see FIG. 3) of housing 1, and thus, outer shield 31 is held by housing 1.

The pair of second extension parts 3113 is curved inward and extends downward from upper ends of a front portion and a rear portion of outer wall 3111. In the front-rear direction, first extension part 3112 is disposed between the pair of second extension parts 3113. However, first extension part 3112 and second extension part 3113 are not connected in the front-rear direction, and there is gap 3115 between first extension part 3112 and second extension part 3113.

As illustrated in FIG. 12, a lowermost end of second extension part 3113 is above an uppermost end of outer wall 12 of housing 1. The lowermost end of second extension part 3113 overlaps the uppermost end of outer wall 12 (more specifically, first portion 1211 of partial wall part 121) of housing 1 in the upper-lower direction via gap G10.

Flange 3114 extends outward from a lower end of outer wall 3111. Flange 3114 is a portion connected to circuit board B1 in outer shield 31. Flange 3114 is fixed to and electrically connected to a ground pattern of circuit board B1 by, for example, soldering or the like.

Of the pair of first outer shields 311, first outer shield 311 on a left side is aligned with first partition wall 151 of first end wall part 15 in the left-right direction. Of the pair of first outer shields 311, first outer shield 311 on a right side is aligned with third partition wall 153 of first end wall part 15 in the left-right direction.

As illustrated in FIGS. 3 and 4, the pair of second outer shields 312 is formed long in the left-right direction on the front side and the rear side of housing 1. The pair of second outer shields 312 is disposed to face each other in the front-rear direction.

Of the pair of second outer shields 312, second outer shield 312 on a front side is disposed in front of first predetermined terminal 21 and faces first end wall part 15 and first predetermined terminal 21. As described above, shield 3 has side wall 310 positioned in front of first predetermined terminal 21. Side wall 310 includes outer wall 3121 and extension part 3122 of second outer shield 312 on the front side.

Of the pair of second outer shields 312, second outer shield 312 on a rear side is disposed behind second predetermined terminal 22 and faces second end wall part 16 and second predetermined terminal 22. As described above, shield 3 has a side wall positioned behind second predetermined terminal 22. The side wall includes outer wall 3121 and extension part 3122 of second outer shield 312 on the rear side. Each of the pair of second outer shields 312 is coupled to the pair of first outer shields 311.

Second outer shield 312 includes outer wall 3121, extension part 3122, and flange 3123.

Outer wall 3121 has a wall shape facing entire housing 1 in the left-right direction. Outer wall 3121 is disposed outward with respect to outer wall 12 (more specifically, second portion 1212 of partial wall part 121) of housing 1 in the front-rear direction.

Extension part 3122 is curved inward and extends downward from an upper end of outer wall 3121.

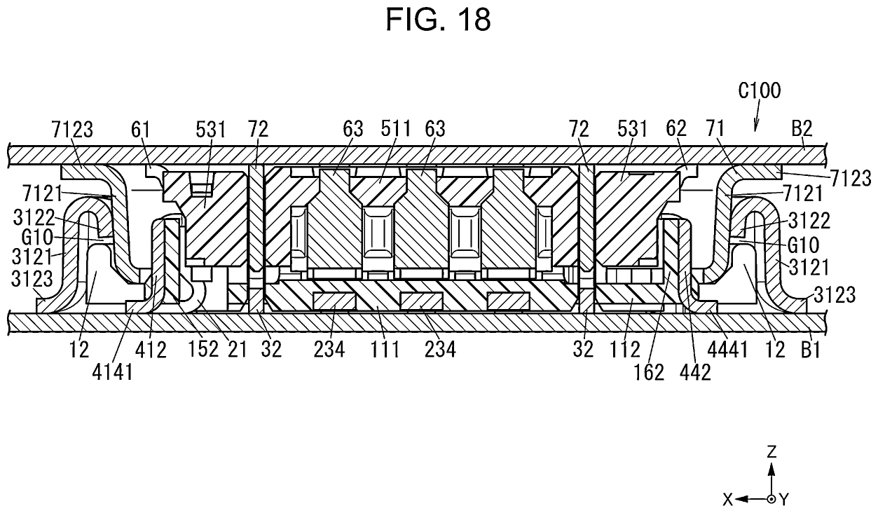

As illustrated in FIG. 18, a lowermost end of extension part 3122 is above the uppermost end of outer wall 12 of housing 1. Lowermost ends of left and right end parts of extension part 3122 overlap the uppermost end of outer wall 12 (more specifically, second portion 1212 of partial wall part 121) of housing 1 in the upper-lower direction via gap G10.

Flange 3123 extends outward from a lower end of outer wall 3121. Flange 3123 is a portion of outer shield 31 connected to circuit board B1. Flange 3123 is fixed to and electrically connected to a ground pattern of circuit board B1 by, for example, soldering or the like.

Of the pair of second outer shields 312, second outer shield 312 on the front side is aligned in the front-rear direction with second partition wall 152 of first end wall part 15. Of the pair of second outer shields 312, second outer shield 312 on the rear side is aligned in the front-rear direction with the second partition wall 162 of second end wall part 16.

As illustrated in FIGS. 3 and 4, an end of first outer shield 311 and an end of second outer shield 312 are connected to each other, and thus, outer shield 31 is formed in a rectangular frame shape surrounding a hollow space as viewed from above. The plurality of terminals 2 are disposed inside outer shield 31 having a rectangular frame shape. That is, outer shield 31 surrounds the plurality of terminals 2. It can also be said that shield 3 surrounds the plurality of terminals 2. As a result, electromagnetic shielding properties are improved.

An outer surface of outer shield 31 is seamless over an entire circumference in a circumferential direction. “Seamless” means that there is no joint or break.

### (1.2.3.2) Inner Shield

Shield 3 includes two inner shields 32. Inner shield 32 contains metal as a main material or a material such as plating constituting a surface. Here, as an example, inner shield 32 is formed by using metal as a main material.

In the present exemplary embodiment, shapes of two inner shields 32 are the same. Inner shield 32 has a plate shape whose thickness direction is along the front-rear direction. As illustrated in FIG. 3, inner shield 32 integrally includes base 321 and a plurality of (a pair of) protrusions 322.

Base 321 has a plate shape long in the left-right direction.

Protrusion 322 protrudes upward from base 321. The pair of protrusions 322 is provided at symmetrical positions in the left-right direction at an upper end of base 321.

As illustrated in FIGS. 4 and 6, in inner shield 32, base 321 is accommodated in accommodation hole 1121 of outer bottom wall 112 of housing 1, and the pair of protrusions 322 is press-fitted into the pair of accommodation grooves 142 of central wall part 14 and is held by housing 1.

As illustrated in FIG. 4, first predetermined terminal 21 is surrounded by outer shield 31 (the pair of first outer shields 311 and second outer shield 312 on the front side) and inner shield 32 on a front side. Second predetermined terminal 22 is surrounded by outer shield 31 (the pair of first outer shields 311 and second outer shield 312 on the rear side) and inner shield 32 on the rear side. As described above, first predetermined terminal 21 is surrounded by shield 3, and second predetermined terminal 22 is surrounded by shield 3.

Inner shield 32 is connected to circuit board B1. Base 321 of inner shield 32 is fixed to and electrically connected to a ground pattern of circuit board B1 by, for example, soldering or the like. As a result, outer shield 31 and inner shield 32 have the same potential.

### (1.2.4) Guard

As illustrated in FIGS. 3 to 5, guard 4 includes first guard member 41, second guard member 42, third guard member 43, and fourth guard member 44 which are separated from each other.

First guard member 41 to fourth guard member 44 contain metal as a main material or a material such as plating constituting a surface. Here, as an example, first guard member 41 to fourth guard member 44 are mainly made of metal. That is, guard 4 (first guard member 41 to fourth guard member 44) is made of metal. Guard 4 is formed by punching or bending a metal plate.

Guard 4 (first guard member 41 to fourth guard member 44) is electrically insulated from shield 3 (outer shield 31 and inner shield 32) and the plurality of terminals 2. That is, first guard member 41 to fourth guard member 44 do neither come into contact with shield 3 nor the plurality of terminals 2, and are not electrically connected.

Guard 4 is held by housing 1. First guard member 41 to fourth guard member 44 are held by housing 1. First guard member 41 and second guard member 42 are held by first end wall part 15 of housing 1. Third guard member 43 and fourth guard member 44 are held by second end wall part 16 of housing 1.

First guard member 41 covers at least a part of first end wall part 15. As illustrated in FIG. 4, first guard member 41 is disposed at a portion on a left front side of first end wall part 15, and covers a coupling part (including a corner part) of first end wall part 15 between first partition wall 151 and second partition wall 152.

As illustrated in FIG. 5, first guard member 41 includes first site 411, second site 412, corner site 413, and a board connecting part 414.

First site 411 has a plate shape whose thickness direction is along the left-right direction. First site 411 covers a left side surface of first partition wall 151 of first end wall part 15. First site 411 covers at least an upper end portion of the left side surface of first partition wall 151, and covers from an upper end to a lower end in the present exemplary embodiment. First site 411 faces one of the pair of first outer shields 311 (first outer shield 311 on a left side) in the left-right direction (see FIG. 4).

In the present exemplary embodiment, first site 411 covers from an upper end to a lower end of first partition wall 151. Specifically, an uppermost end of first site 411 and an uppermost end of the left side surface of first partition wall 151 have the same height in the upper-lower direction (see FIGS. 2 and 12). The uppermost end of first site 411 may be higher or slightly lower in height in the upper-lower direction than the uppermost end on the left side surface of first partition wall 151. First site 411 covers from a front end to a rear end of the left side surface of first partition wall 151. Specifically, a rearmost end of first site 411 and a rearmost end on the left side surface of first partition wall 151 have the same position in the front-rear direction (see FIGS. 2 and 4). The rearmost end of first site 411 and the rearmost end on the left side surface of first partition wall 151 may be different in position in the front-rear direction.

Second site 412 has a plate shape whose thickness direction is along the front-rear direction. Second site 412 covers a front side surface of a left end portion of second partition wall 152 of first end wall part 15. Second site 412 covers at least an upper end portion of a front side surface of second partition wall 152, and covers from an upper end to a lower end in the present exemplary embodiment. Second site 412 faces second outer shield 312 on the front side in the front-rear direction (see FIG. 4). As illustrated in FIG. 5, second site 412 has protruding part 415 that protrudes to one side (right side) in the left-right direction at one end part (right side) of second site 412 in the left-right direction and is buried in housing 1.

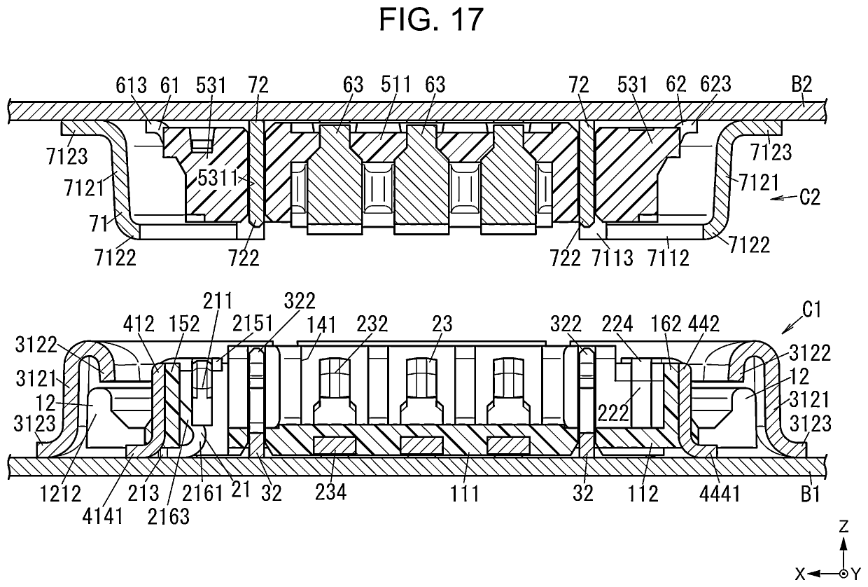

In the present exemplary embodiment, second site 412 covers from an upper end to a lower end of the left end portion of second partition wall 152. Specifically, an uppermost end of second site 412 and an uppermost end of the front side surface of second partition wall 152 have the same height in the upper-lower direction (see FIGS. 2 and 17). The uppermost end of second site 412 may be higher or slightly lower in height in the upper-lower direction than an uppermost end of a front side surface of the left end portion of second partition wall 152.

As described above, guard 4 (first guard member 41) is disposed between first predetermined terminal 21 and shield 3 (outer shield 31) as viewed from above, and covers at least a part of first end wall part 15. Guard 4 (first guard member 41) covers at least a part of at least one of first partition wall 151 and second partition wall 152.

Guard 4 (first site 411 of first guard member 41) faces the pair of first outer shields 311 in the left-right direction. Guard 4 (first site 411 of first guard member 41) is disposed between one of the pair of first outer shields 311 (first outer shield 311 on the left side) and first predetermined terminal 21 in the left-right direction. Guard 4 (second site 412 of first guard member 41) faces second outer shield 312 in the front-rear direction.

As illustrated in FIG. 4, a front end of guard 4 (a front end of second site 412 of first guard member 41) is at the same position as a front end of first predetermined terminal 21 (the front end of proximity part 2162) or in front of the front end of first predetermined terminal 21 (here, at the same position) in the front-rear direction.

As illustrated in FIG. 5, corner site 413 has a plate shape curved in an R shape. A front end of first site 411 and second site 412 are disposed in an L shape as viewed from above. Corner site 413 connects first site 411 and second site 412. Corner site 413 connects the front end of first site 411 and a left end of second site 412 (one end in the left-right direction). Corner site 413 covers at least an upper end portion of a corner part connecting first partition wall 151 and second partition wall 152.

Board connecting part 414 is a portion of first guard member 41 fixed to circuit board B1. Board connecting part 414 is configured to be connected to circuit board B1.

Board connecting part 414 includes first board connecting part 4141 and second board connecting part 4142.

First board connecting part 4141 has a plate shape whose thickness direction is along the upper-lower direction. First board connecting part 4141 is coupled to a lower end of second site 412 via a curved part curved in an R shape. A portion coupling second site 412 and the curved part is buried in housing 1 to penetrate housing 1. First board connecting part 4141 is fixed to circuit board B1 by, for example, soldering or the like. As illustrated in FIG. 4, first board connecting part 4141 protrudes forward from the front end of housing 1 and is disposed to be exposed in a region between housing 1 and outer shield 31 as viewed from above. Thus, whether or not first board connecting part 4141 is fixed to circuit board B1 (whether or not soldering is performed) can be visually confirmed, for example.

Second board connecting part 4142 has a plate shape extending downward from a lower end of first site 411. A portion coupling first site 411 and second board connecting part 4142 is buried in housing 1 to penetrate housing 1. A thickness direction of second board connecting part 4142 is along the left-right direction. As illustrated in FIG. 6, second board connecting part 4142 is exposed on the lower surface of housing 1. A distal end surface of second board connecting part 4142 is fixed to circuit board B1 by, for example, soldering or the like. board connecting part 414 includes second board connecting part 4142, and thus, first guard member 41 can be firmly fixed to circuit board B1.

Here, first guard member 41 is not connected to a ground pattern of circuit board B1 or a circuit pattern of the signal transmission and power supply. That is, first board connecting part 4141 of first guard member 41 is fixed to fixing pads of circuit board B1 by soldering, but the fixing pads are not connected to an electric circuit (conductive pattern) formed on circuit board B1. That is, board connecting part 414 of first guard member 41 is fixed to circuit board B1 by soldering or the like only for physical connection of first guard member 41 to circuit board B1. In a state where connector C1 is mounted on circuit board B1, guard 4 (first guard member 41) is electrically insulated from terminal 2 and shield 3. Guard 4 (first guard member 41) is in a so-called floating state. Guard 4 is electrically insulated from terminal 2 and shield 3, and thus, it is possible to improve signal transmission performance in a case where a high-frequency signal is transmitted via the electric path including first predetermined terminal 21.

Second guard member 42 covers at least a part of first end wall part 15. As illustrated in FIG. 4, second guard member 42 is disposed in a portion on a right front side of first end wall part 15, and covers a coupling part (including a corner part) of first end wall part 15 between second partition wall 152 and third partition wall 153. Second guard member 42 is disposed to be separated from first guard member 41 in the left-right direction. In the left-right direction, at least a part of first contact part 211 and second contact part 212 is disposed between first guard member 41 and second guard member 42.

Second guard member 42 has a shape symmetrical with first guard member 41 in the left-right direction. Thus, a detailed description of second guard member 42 is omitted. Note that second guard member 42 includes first site 421, second site 422, corner site 423, board connecting part 424 (first board connecting part 4241 and second board connecting part 4242), and protruding part 425 to correspond to first site 411, second site 412, corner site 413, board connecting part 414 (first board connecting part 4141 and second board connecting part 4142), and protruding part 415 of first guard member 41, respectively.

Third guard member 43 covers at least a part of second end wall part 16. As illustrated in FIG. 4, third guard member 43 is disposed in a portion on a right rear side of second end wall part 16, and covers a coupling portion (including a corner part) of second end wall part 16 between the first partition wall 161 and the second partition wall 162.

Third guard member 43 has a shape obtained by rotating first guard member 41 by 180 degrees around axis A1 (see FIG. 2). Thus, a detailed description of third guard member 43 is omitted. Note that third guard member 43 includes first site 431, second site 432, corner site 433, board connecting part 434 (first board connecting part 4341 and second board connecting part 4342), and protruding part 435 to correspond to first site 411, second site 412, corner site 413, board connecting part 414 (first board connecting part 4141 and second board connecting part 4142), and protruding part 415 of first guard member 41, respectively.

Fourth guard member 44 covers at least a part of second end wall part 16. As illustrated in FIG. 4, fourth guard member 44 is disposed in a portion on a left rear side of second end wall part 16, and covers a coupling part (including a corner part) of second end wall part 16 between the first partition wall 161 and the third partition wall 163.

Fourth guard member 44 has a shape symmetrical with first guard member 41 in the front-rear direction. Thus, a detailed description of fourth guard member 44 is omitted. Note that fourth guard member 44 includes first site 441, second site 442, corner site 443, board connecting part 444 (first board connecting part 4441 and second board connecting part 4442), and protruding part 445 to correspond to first site 411, second site 412, corner site 413, board connecting part 414 (first board connecting part 4141 and second board connecting part 4142), and protruding part 415 of first guard member 41, respectively.

### (1.3) Mating Connector

As illustrated in FIGS. 7 to 10, mating connector C2 includes mating housing 5, a plurality of mating terminals 6, and mating shield 7.

### (1.3.1) Mating Housing

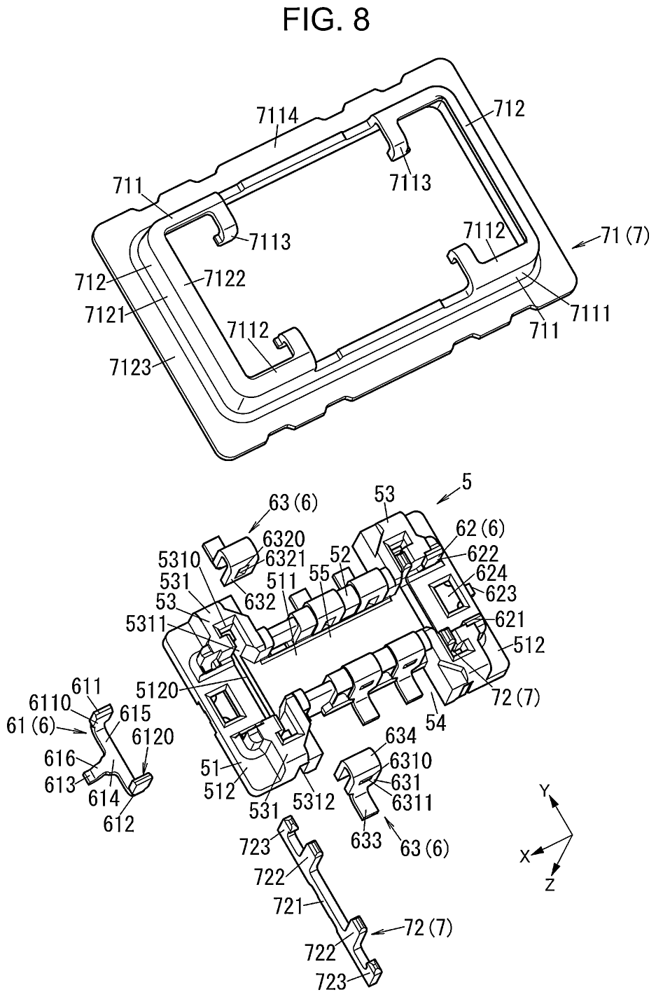

Mating housing 5 is made of an insulating resin material and is formed in a substantially rectangular parallelepiped shape long in the front-rear direction as illustrated in FIG. 8. Mating housing 5 has a two-fold rotationally symmetric shape around axis A2 (see FIG. 7) that passes through a center of mating housing 5 and is along the upper-lower direction. Mating housing 5 holds the plurality of mating terminals 6 and mating shield 7.

As illustrated in FIG. 8, mating housing 5 integrally includes mating bottom wall 51, a pair of mating side wall parts 52, and a pair of mating holding wall parts 53.

Mating bottom wall 51 has a plate shape whose thickness direction is along the upper-lower direction. Mating bottom wall 51 integrally includes mating inner bottom wall 511 and a pair of mating outer bottom walls 512.

Mating inner bottom wall 511 has a rectangular plate shape as viewed from below.

The pair of mating outer bottom walls 512 is connected to both front and rear ends of mating inner bottom wall 511, respectively. Each of the pair of mating outer bottom walls 512 has a rectangular shape as viewed from below, and has a plate shape whose dimension in the left-right direction is larger than a dimension of mating inner bottom wall 511.

On left and right side surfaces of mating bottom wall 51, there is a step at a joint portion between mating inner bottom wall 511 and mating outer bottom wall 512. As a result, mating housing 5 has mating dent 54 at a center in the front-rear direction on both left and right side surfaces, and is formed in an H shape in bottom view.

The pair of mating side wall parts 52 protrudes downward from mating bottom wall 51. The pair of mating side wall parts 52 is provided at peripheral portions (left edge and right edge) of mating inner bottom wall 511. Mating side wall part 52 has a wall shape long in the front-rear direction. Mating recess 55 is formed to be surrounded by mating inner bottom wall 511 and the pair of mating side wall parts 52.

The pair of mating holding wall parts 53 protrudes downward from mating bottom wall 51. One of the pair of mating holding wall parts 53 is provided on mating outer bottom wall 512 on the front side. The other of the pair of mating holding wall parts 53 is provided on mating outer bottom wall 512 on the rear side.

Each of the pair of mating holding wall parts 53 has two mating partial wall parts 531. Two mating partial wall parts 531 face each other with a gap therebetween in the left-right direction. Each of two mating partial wall parts 531 is connected to the pair of mating side wall parts 52 in the front-rear direction.

At a center of a lower surface of mating partial wall part 531, holding dent 5310 is formed to be recessed upward.

In each of two mating partial wall parts 531, first mating accommodation groove 5311 is formed on facing surfaces in the left-right direction. Mating accommodation hole 5120 long in the left-right direction is formed in mating outer bottom wall 512 to connect first mating accommodation grooves 5311 of two mating partial wall parts 531. In each of two mating partial wall parts 531, second mating accommodation groove 5312 is formed on an outer side surface in the left-right direction.

### (1.3.2) Mating Terminal

As illustrated in FIGS. 7 to 10, mating connector C2 includes a plurality of (here, eight) mating terminals 6. Mating terminal 6 is made of metal. The plurality of mating terminals 6 are held by mating housing 5. The plurality of mating terminals 6 are electrically connected to the plurality of terminals 2 included in connector C1 in the connected state where connector C1 and mating connector C2 are connected.

Here, the plurality of mating terminals 6 include first mating predetermined terminal 61, second mating predetermined terminal 62, and a plurality of (here, six) mating connection terminals 63. First mating predetermined terminal 61 and second mating predetermined terminal 62 are, for example, high frequency terminals for transmitting relatively high frequency signals. The plurality of mating connection terminals 63 are, for example, low frequency terminals for transmitting relatively low frequency signals.

### (1.3.2.1) Mating Predetermined Terminal

First mating predetermined terminal 61 is disposed on a foremost side in the front-rear direction, among the plurality of mating terminals 6. First mating predetermined terminal 61 is connected to first predetermined terminal 21 of connector C1.

As illustrated in FIG. 8, first mating predetermined terminal 61 integrally includes first mating contact part 611, second mating contact part 612, mating board connecting part 613, and mating coupling part 614.

First mating contact part 611 and second mating contact part 612 are portions of first mating predetermined terminal 61 that come into contact with first predetermined terminal 21 of connector C1 in the connected state where connector C1 and mating connector C2 are connected. First mating contact part 611 includes first mating contact point 6110 that comes into contact with first contact point 2110 of first predetermined terminal 21. Second mating contact part 612 includes second mating contact point 6120 that comes into contact with second contact point 2120 of first predetermined terminal 21. First mating contact part 611 and second mating contact part 612 are disposed to be aligned in the left-right direction. First mating contact part 611 is positioned on a left side, and second mating contact part 612 is positioned on a right side.

First mating contact part 611 has a plate shape whose thickness direction is along the left-right direction. First mating contact part 611 has a flat plate shape. First mating contact point 6110 includes a right surface (plane) of first mating contact part 611. That is, first mating contact point 6110 is formed on a facing surface (right surface) of first mating contact part 611 facing second mating contact part 612.

Second mating contact part 612 has a plate shape whose thickness direction is along the left-right direction. Second mating contact part 612 has a flat plate shape. Second mating contact point 6120 includes a left surface (plane) of second mating contact part 612. That is, second mating contact point 6120 is formed on a facing surface (left surface) of second mating contact part 612 facing first mating contact part 611.

Mating board connecting part 613 is configured to be connected to mating circuit board B2. Mating board connecting part 613 has a plate shape whose thickness direction is along the upper-lower direction. Mating board connecting part 613 has a flat plate shape. Mating board connecting part 613 is fixed to and electrically connected to pads of mating circuit board B2 by, for example, soldering or the like.

Mating coupling part 614 couples first mating contact part 611, second mating contact part 612, and mating board connecting part 613.

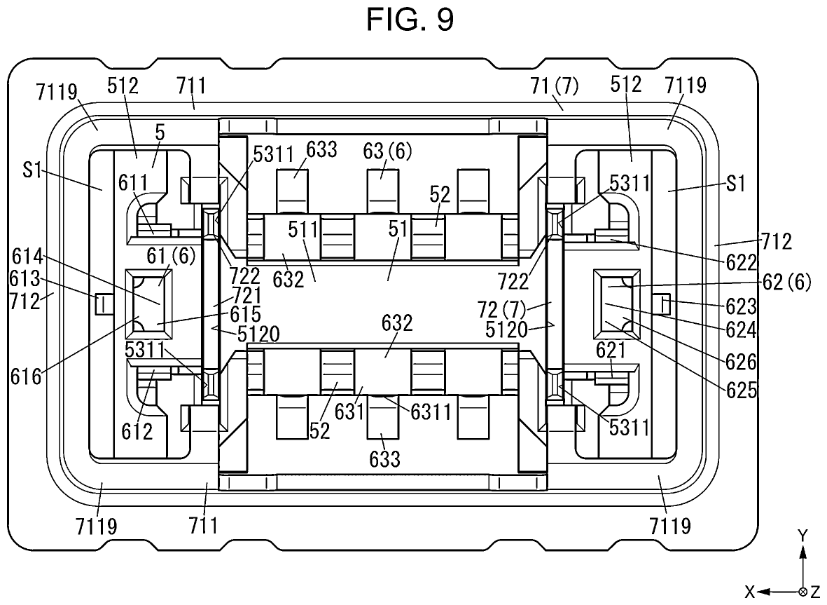

As illustrated in FIGS. 8 and 9, mating coupling part 614 includes first mating coupling part 615 and second mating coupling part 616.

First mating coupling part 615 couples first mating contact part 611 and second mating contact part 612. As illustrated in FIG. 8, first mating coupling part 615 has a plate shape whose thickness direction is along the upper-lower direction.

A first end (left end) of first mating coupling part 615 is coupled to an upper end of first mating contact part 611 via a curved part curved in an R shape. A second end (right end) of first mating coupling part 615 is coupled to an upper end of second mating contact part 612 via a curved part curved in an R shape. First mating contact part 611, second mating contact part 612, and first mating coupling part 615 are formed in a U shape.

Second mating coupling part 616 couples first mating coupling part 615 and mating board connecting part 613. That is, second mating coupling part 616 couples the mating contact parts (first mating contact part 611 and second mating contact part 612) and mating board connecting part 613. Second mating coupling part 616 has a curved plate shape, and couples a front end of a central portion of first mating coupling part 615 in the left-right direction and a rear end of mating board connecting part 613 such that mating board connecting part 613 is positioned obliquely forward and upward of first mating coupling part 615.

As illustrated in FIGS. 7 to 10, first mating predetermined terminal 61 is buried in mating outer bottom wall 512 and mating holding wall part 53 on the front side of mating housing 5 and is held by mating housing 5.

First mating contact part 611 is fixed to mating housing 5. First mating contact part 611 comes into contact with one mating partial wall part 531 (on the left side) on an outer surface (left surface) opposite to a surface on which first mating contact point 6110 is formed. First mating contact part 611 is partially buried in mating partial wall part 531 on the left side of mating holding wall part 53 on the front side such that a right surface including first mating contact point 6110 is exposed.

Second mating contact part 612 is fixed to mating housing 5. Second mating contact part 612 comes into contact with other mating partial wall part 531 (on the right side) on an outer surface (right surface) opposite to a surface on which second mating contact point 6120 is formed. Second mating contact part 612 is partially buried in mating partial wall part 531 on the right side of mating holding wall part 53 on the front side such that a left surface including second mating contact point 6120 is exposed.

As described above, mating housing 5 has a pair of mating partial wall parts 531 that comes into contact with first mating contact part 611 and second mating contact part 612, respectively, outside first mating contact part 611 and second mating contact part 612 in the left-right direction.

Mating coupling part 614 is buried in mating outer bottom wall 512 on the front side. A dent is formed at a center of a lower surface of mating outer bottom wall 512, and a central portion in the left-right direction on a lower surface of mating coupling part 614 is exposed via the dent.

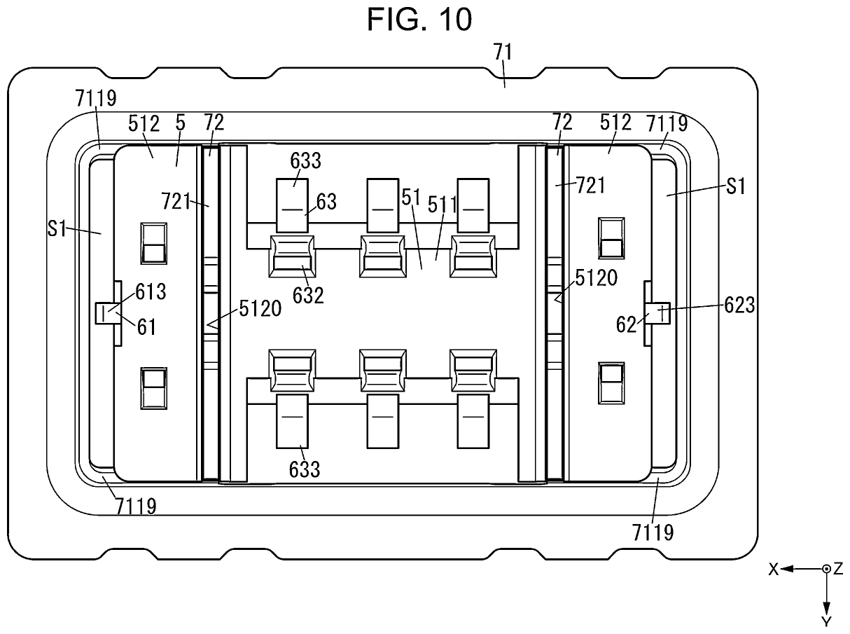

As illustrated in FIGS. 9 and 10, mating board connecting part 613 protrudes forward from a front end of mating housing 5. An upper surface of mating board connecting part 613 is exposed from mating housing 5. As illustrated in FIG. 19, the upper surface of mating board connecting part 613 is at the same position as the upper surface of mating housing 5 or above the upper surface of mating housing 5 in the upper-lower direction (in the present exemplary embodiment, on the upper side).

As illustrated in FIG. 7, second mating predetermined terminal 62 is disposed rearmost in the front-rear direction, among the plurality of mating terminals 6. Second mating predetermined terminal 62 is connected to second predetermined terminal 22 of connector C1.

Second mating predetermined terminal 62 has a shape obtained by rotating first mating predetermined terminal 61 by 180 degrees around axis A2 (see FIG. 7) set in mating housing 5. Thus, a detailed description of second mating predetermined terminal 62 is omitted. Note that second mating predetermined terminal 62 includes first mating contact part 621, second mating contact part 622, mating board connecting part 623, and mating coupling part 624 (first mating coupling part 625 and second mating coupling part 626) to correspond to first mating contact part 611, second mating contact part 612, mating board connecting part 613, and mating coupling part 614 (first mating coupling part 615 and second mating coupling part 616) of first mating predetermined terminal 61, respectively.

### (1.3.2.2) Mating Connection Terminal

As illustrated in FIGS. 7 to 10, the plurality of mating connection terminals 63 are disposed between first mating predetermined terminal 61 and second mating predetermined terminal 62 in the front-rear direction. The plurality of mating connection terminals 63 are connected to the plurality of connection terminals 23 of connector C1, respectively.

The plurality of mating connection terminals 63 are held by the pair of mating side wall parts 52 of mating housing 5. Here, six mating connection terminals 63 are held to be aligned in the front-rear direction, three for each of the pair of mating side wall parts 52.

As illustrated in FIG. 8, mating connection terminal 63 integrally includes third mating contact part 631, fourth mating contact part 632, mating board connecting part 633, and mating coupling part 634.

Third mating contact part 631 and fourth mating contact part 632 are portions of mating connection terminal 63 that come into contact with connection terminal 23 of connector C1 in the connected state where connector C1 and mating connector C2 are connected. Third mating contact part 631 includes third mating contact point 6310 that comes into contact with third contact point 2310 of connection terminal 23. Fourth mating contact part 632 includes fourth mating contact point 6320 that comes into contact with fourth contact point 2320 of connection terminal 23. Third mating contact part 631 and fourth mating contact part 632 are disposed to be aligned in the left-right direction.

Third mating contact part 631 has a plate shape whose thickness direction is along the left-right direction. Third mating contact part 631 has a flat plate shape. Third mating contact point 6310 is formed on a surface of third mating contact part 631 opposite to a facing surface facing fourth mating contact part 632. Third mating contact part 631 has projection 6311 on a surface opposite to a facing surface facing fourth mating contact part 632. Third mating contact point 6310 includes projection 6311.

Fourth mating contact part 632 has a plate shape whose thickness direction is along the left-right direction. Fourth mating contact part 632 has a flat plate shape. Fourth mating contact part 632 is disposed inside third mating contact part 631 in the left-right direction. Fourth mating contact point 6320 is formed on a surface of fourth mating contact part 632 opposite to a facing surface facing third mating contact part 631. Fourth mating contact part 632 has recess 6321 on the surface opposite to the facing surface facing third mating contact part 631. Fourth mating contact point 6320 includes recess 6321.

Mating board connecting part 633 is configured to be connected to mating circuit board B2. Mating board connecting part 633 has a plate shape whose thickness direction is along the upper-lower direction. Mating board connecting part 633 has a flat plate shape. Mating board connecting part 633 is fixed to and electrically connected to pads of mating circuit board B2 by, for example, soldering or the like. Mating board connecting part 633 is coupled to an upper end of third mating contact part 631 via a curved part.

Mating coupling part 634 couples third mating contact part 631 and fourth mating contact part 632. Mating coupling part 634 has a U-shaped plate shape that couples a lower end of third mating contact part 631 and a lower end of fourth mating contact part 632.

Mating connection terminal 63 is fixed to mating housing 5. Mating connection terminal 63 is held by mating housing 5 to straddle left and right side surfaces of mating side wall part 52 of mating housing 5.

Third mating contact part 631 is fixed to mating housing 5. In third mating contact part 631, third mating contact point 6310 is disposed in mating dent 54 and is held by mating side wall part 52. Fourth mating contact part 632 is fixed to mating housing 5. In fourth mating contact part 632, fourth mating contact point 6320 is disposed in mating recess 55 and is held by mating side wall part 52.

As illustrated in FIG. 10, an upper surface of mating board connecting part 633 is exposed from mating housing 5. As illustrated in FIG. 15, the upper surface of mating board connecting part 633 is at the same position as the upper surface of mating housing 5 or above the upper surface of mating housing 5 in the upper-lower direction (in the present exemplary embodiment, on the upper side). The upper surface of mating board connecting part 633 is at the same position as the upper surface of mating board connecting part 613 of first mating predetermined terminal 61 and the upper surface of the mating board connecting part 623 of second mating predetermined terminal 62 in the upper-lower direction. As illustrated in FIGS. 9 and 10, mating board connecting part 633 protrudes outward in the left-right direction from mating inner bottom wall 511 of mating housing 5.

### (1.3.3) Mating Shield

As illustrated in FIGS. 7 to 10, mating shield 7 includes mating outer shield 71 and mating inner shield 72. Mating shield 7 is electrically connected to shield 3 included in connector C1 in the connected state where connector C1 and the mating connector C2 are connected.

### (1.3.3.1) Mating Outer Shield

Mating outer shield 71 contains metal as a main material or a material such as plating constituting a surface. Here, as an example, mating outer shield 71 is formed by using metal as a main material.

Mating outer shield 71 is connected to outer shield 31 of connector C1 in the connected state where connector C1 and mating connector C2 are connected.

As illustrated in FIGS. 8 and 9, mating outer shield 71 integrally includes a pair of first mating outer shields 711 and a pair of second mating outer shields 712.

As illustrated in FIGS. 8 and 9, the pair of first mating outer shields 711 is formed to be long in the front-rear direction on a left side and a right side of mating housing 5. The pair of first mating outer shields 711 faces each other in the left-right direction. First mating predetermined terminal 61, second mating predetermined terminal 62, and the plurality of mating connection terminals 63 are disposed between the pair of first mating outer shields 711. As described above, the pair of first mating outer shields 711 is disposed to face each other in the left-right direction with first mating predetermined terminal 61 and second mating predetermined terminal 62 interposed therebetween.

As illustrated in FIG. 8, first mating outer shield 711 includes mating outer wall 7111, a pair of mating extension parts 7112, a pair of additional extension parts 7113, and mating flange 7114.

Mating outer wall 7111 has a wall shape facing entire mating housing 5 in the front-rear direction. Mating outer wall 7111 is disposed outward with respect to mating housing 5 in the left-right direction.

The pair of mating extension parts 7112 is disposed on both sides of mating outer wall 7111 in the front-rear direction. The pair of mating extension parts 7112 has a shape curved inward in an L shape from lower ends of a front side portion and a rear side portion of mating outer wall 7111. A space between the pair of mating extension parts 7112 in the front-rear direction is a portion (central portion in the front-rear direction) corresponding to mating inner bottom wall 511 of mating housing 5. Mating extension part 7112 is not formed and there is a gap between the pair of mating extension parts 7112 in the front-rear direction.

The pair of additional extension parts 7113 is curved inward in an L shape and extends upward from an inner end in the front-rear direction of each of the pair of mating extension parts 7112. Additional extension part 7113 is inserted into holding dent 5310 formed in the lower surface of mating partial wall part 531 of mating holding wall part 53 of mating housing 5. A total of four additional extension parts 7113 included in mating outer shield 71 are press-fitted into a total of four holding dents 5310 included in mating housing 5, and thus, mating outer shield 71 is held by mating housing 5. Mating outer shield 71 includes additional extension parts 7113, and thus, positioning can be easily performed when mating outer shield 71 is attached to mating housing 5.

Mating flange 7114 extends outward from an upper end of mating outer wall 7111. Mating flange 7114 is a portion of mating outer shield 71 connected to mating circuit board B2. Mating flange 7114 is fixed to and electrically connected to a ground pattern of mating circuit board B2 by, for example, soldering or the like.

Here, first mating outer shield 711 has a length longer in the front-rear direction than mating housing 5. Thus, a front end and a rear end of first mating outer shield 711 do not overlap mating housing 5 in the upper-lower direction. That is, first mating outer shield 711 has non-overlapping portions 7119 (sec FIGS. 9 and 10) that do not overlap mating housing 5 in the upper-lower direction at both ends in the front-rear direction. Non-overlapping portion 7119 of one first mating outer shield 711 faces non-overlapping portion 7119 of other first mating outer shield 711 via space S1 as viewed from the upper-lower direction.

As illustrated in FIGS. 8 and 9, the pair of second mating outer shields 712 is formed to be long in the left-right direction on a front side and a rear side of mating housing 5. The pair of second mating outer shields 712 is disposed to face each other in the front-rear direction. Of the pair of second mating outer shields 712, second mating outer shield 712 on a front side is disposed in front of first mating predetermined terminal 61. Second mating outer shield 712 on the front side is coupled to front ends of the pair of first mating outer shields 711. Of the pair of second mating outer shields 712, second mating outer shield 712 on a rear side is disposed behind second mating predetermined terminal 62. Second mating outer shield 712 on the rear side is coupled to rear ends of the pair of first mating outer shields 711.

As illustrated in FIG. 8, second mating outer shield 712 includes mating outer wall 7121, mating extension part 7122, and mating flange 7123.

Mating outer wall 7121 has a wall shape facing entire mating housing 5 in the left-right direction. Mating outer wall 7121 is disposed outward with respect to mating housing 5 in the front-rear direction.

Mating extension part 7122 is curved inward from a lower end of mating outer wall 7121.

Mating flange 7123 extends outward from an upper end of mating outer wall 7121. Mating flange 7123 is a portion connected to mating circuit board B2 in mating outer shield 71. Mating flange 7123 is fixed to and electrically connected to the ground pattern of mating circuit board B2 by, for example, soldering or the like.

As illustrated in FIGS. 9 and 10, entire second mating outer shield 712 does not overlap mating housing 5 in the upper-lower direction. Second mating outer shield 712 on the front side faces a foremost end of mating housing 5 via space S1 as viewed from the upper-lower direction. Second mating outer shield 712 on the rear side faces the rearmost end of mating housing 5 via space S1 as viewed from the upper-lower direction.

As illustrated in FIGS. 8 and 9, an end of first mating outer shield 711 and an end of second mating outer shield 712 are connected to each other, and thus, mating outer shield 71 is formed in a rectangular frame shape surrounding a hollow space as viewed from below. The plurality of mating terminals 6 are disposed inside mating outer shield 71 having a rectangular frame shape. That is, mating outer shield 71 surrounds the plurality of mating terminals 6. Mating shield 7 surrounds the plurality of mating terminals 6. As a result, electromagnetic shielding properties are improved.

An outer surface of mating outer shield 71 is seamless over an entire circumference in a circumferential direction.

### (1.3.3.2) Mating Inner Shield

Mating shield 7 includes two mating inner shields 72. Mating inner shield 72 contains metal as a main material or a material such as plating constituting a surface. Here, as an example, mating inner shield 72 is formed by using metal as a main material.

In the present exemplary embodiment, shapes of two mating inner shields 72 are the same. Mating inner shield 72 has a plate shape whose thickness direction is along the front-rear direction. As illustrated in FIG. 8, mating inner shield 72 integrally includes mating base 721, a plurality of (a pair of) first mating protrusions 722, and a plurality of (a pair of) second mating protrusions 723.

Mating base 721 has a plate shape long in the left-right direction.

First mating protrusion 722 protrudes downward from mating base 721. The pair of first mating protrusions 722 is provided at symmetrical positions in the left-right direction at a lower end of mating base 721.

Second mating protrusion 723 protrudes downward from mating base 721. Second mating protrusion 723 is disposed outside first mating protrusion 722 in the left-right direction. The pair of second mating protrusions 723 is provided at symmetrical positions in the left-right direction at the lower end of mating base 721.

As illustrated in FIGS. 9 and 10, in mating inner shield 72, mating base 721 is accommodated in mating accommodation hole 5120 of mating outer bottom wall 512 of mating housing 5, the pair of first mating protrusions 722 is accommodated in the pair of first mating accommodation grooves 5311 of mating holding wall part 53, and the pair of second mating protrusions 723 is press-fitted into the pair of second mating accommodation grooves 5312 (see FIG. 8) of mating holding wall part 53 and is held by mating housing 5.

As illustrated in FIG. 9, first mating predetermined terminal 61 is surrounded by mating outer shield 71 (the pair of first mating outer shields 711 and second mating outer shield 712 on the front side) and mating inner shield 72 on the front side. Second mating predetermined terminal 62 is surrounded by mating outer shield 71 (the pair of first mating outer shields 711 and second mating outer shield 712 on the rear side) and mating inner shield 72 on the rear side. As described above, first mating predetermined terminal 61 is surrounded by mating shield 7, and second mating predetermined terminal 62 is surrounded by mating shield 7.

In particular, mating inner shield 72 on the front side is aligned in the left-right direction with additional extension part 7113 on the front side of one first mating outer shield 711 and additional extension part 7113 on the front side of other first mating outer shield 711. More specifically, additional extension part 7113 on the front side of first mating outer shield 711 on the left side, mating inner shield 72 on the front side, and additional extension part 7113 on the front side of first mating outer shield 711 on the right side are aligned on a straight line. As a result, the electromagnetic shielding properties of shield 3 are improved. In addition, the rear mating inner shield 72 is aligned in the left-right direction with additional extension part 7113 on the rear side of one first mating outer shield 711 and additional extension part 7113 on the rear side of the other first mating outer shield 711. More specifically, additional extension part 7113 on the rear side of first mating outer shield 711 on the left side, mating inner shield 72 on the rear side, and additional extension part 7113 on the rear side of first mating outer shield 711 on the right side are aligned on a straight line. As a result, the electromagnetic shielding properties of shield 3 are improved.

Mating inner shield 72 is connected to mating circuit board B2. Mating base 721 of mating inner shield 72 is fixed and electrically connected to a ground pattern of mating circuit board B2 by, for example, soldering or the like. As a result, mating outer shield 71 and mating inner shield 72 have the same potential.

### (1.4) Connection of Connector and Mating Connector

Connection between connector C1 and mating connector C2 will be described with reference to FIGS. 1, 2, and 12 to 20.

As illustrated in FIGS. 12 and 15 to 20, connector C1 is mounted on an upper surface of circuit board B1. Mating connector C2 is mounted on a lower surface of mating circuit board B2. In this state, for example, as illustrated in FIGS. 2, 12, 15, 17, and 19, connector C1 is disposed below mating connector C2 (a disconnected state where connector C1 and mating connector C2 are not connected). Then, connector C1 is moved upward and/or mating connector C2 is moved downward, and thus, connector C1 and mating connector C2 are electrically and mechanically connected (the connected state between connector C1 and mating connector C2) as illustrated in FIGS. 1, 13, 16, 18, and 20.

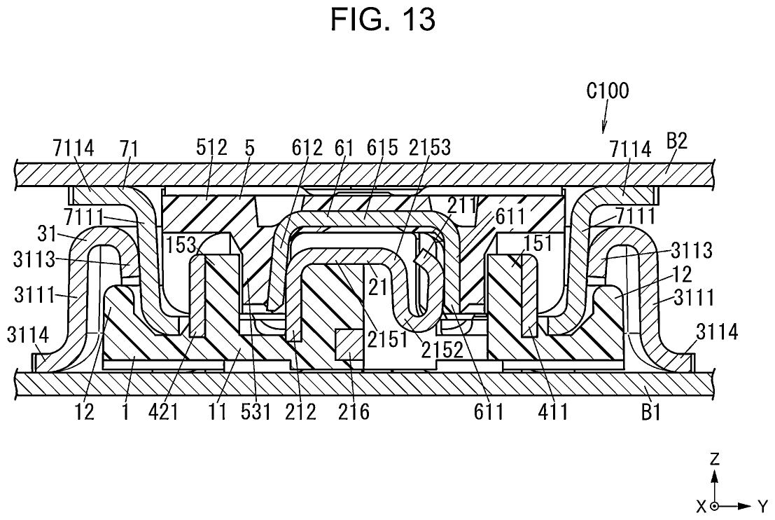

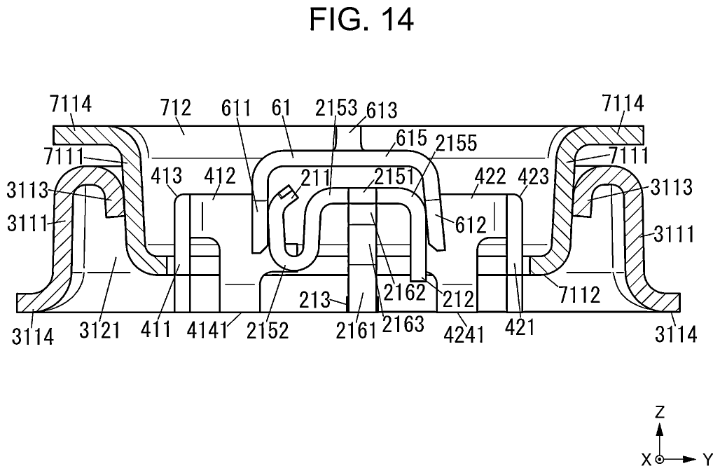

At the time of transition from the disconnected state to the connected state, as illustrated in FIGS. 12 and 13, first contact part 211 of first predetermined terminal 21 is pressed by first mating contact part 611 of first mating predetermined terminal 61, and thus, first coupling part 215 (specifically, first curved part 2152 and second curved part 2153) of first predetermined terminal 21 is elastically deformed. As a result, first contact part 211 moves rightward. In the connected state, as illustrated in FIGS. 13 and 14, first contact part 211 and second contact part 212 of first predetermined terminal 21 come into contact with first mating contact part 611 and second mating contact part 612 of first mating predetermined terminal 61, respectively, and thus, first predetermined terminal 21 and first mating predetermined terminal 61 are electrically connected. At this time, first contact point 2110 of first contact part 211 elastically comes into contact with first mating contact point 6110 of first mating contact part 611 by an elastic return force of first coupling part 215 to return to an original shape.

As illustrated in FIGS. 13 and 14, in the connected state, first contact part 211 and second contact part 212 of first predetermined terminal 21 of connector C1 are disposed between first mating contact part 611 and second mating contact part 612 of first mating predetermined terminal 61 of mating connector C2. Between board connecting part 213 of first predetermined terminal 21 and mating board connecting part 613 of first mating predetermined terminal 61, two conduction paths are formed, that is, a first path passing through first contact part 211 and first mating contact part 611 and a second path passing through second contact part 212 and second mating contact part 612. Note that in FIG. 14, the illustration of housing 1 and mating housing 5 is omitted.

Similarly, at the time of transition from the disconnected state to the connected state, first coupling part 225 of second predetermined terminal 22 is elastically deformed. In the connected state, first contact part 221 and second contact part 222 of second predetermined terminal 22 come into contact with first mating contact part 621 and second mating contact part 622 of second mating predetermined terminal 62, respectively, and thus, second predetermined terminal 22 and second mating predetermined terminal 62 are electrically connected.

As illustrated in FIG. 12, in the disconnected state where connector C1 and mating connector C2 are not connected, first mating coupling part 615 of first mating predetermined terminal 61 of mating connector C2 extends in the left-right direction. First mating contact part 611 and second mating contact part 612 extend linearly in the upper-lower direction. Then, at the time of transition from the disconnected state to the connected state, as illustrated in FIGS. 13 and 14, second mating contact part 612 comes into contact with second contact part 212, and the curved part between first mating coupling part 615 and second mating contact part 612 is elastically deformed. At the time of transition from the disconnected state to the connected state, mating partial wall part 531 on the right side that comes into contact with second mating contact part 612 is deformed outward in conjunction with the deformation of second mating contact part 612. As described above, since second mating contact part 612 is deformed and mating partial wall part 531 is deformed, it is possible to suppress a defect such as breakage of first mating predetermined terminal 61. In the connected state, as illustrated in FIGS. 13 and 14, first mating contact part 611 extends linearly in the upper-lower direction, while second mating contact part 612 extends obliquely with respect to the upper-lower direction. A position of second mating contact part 612 with respect to first mating coupling part 615 in the connected state (see FIG. 13) is a position outside in the left-right direction from a position of second mating contact part 612 with respect to first mating coupling part 615 in the disconnected state (sec FIG. 12).

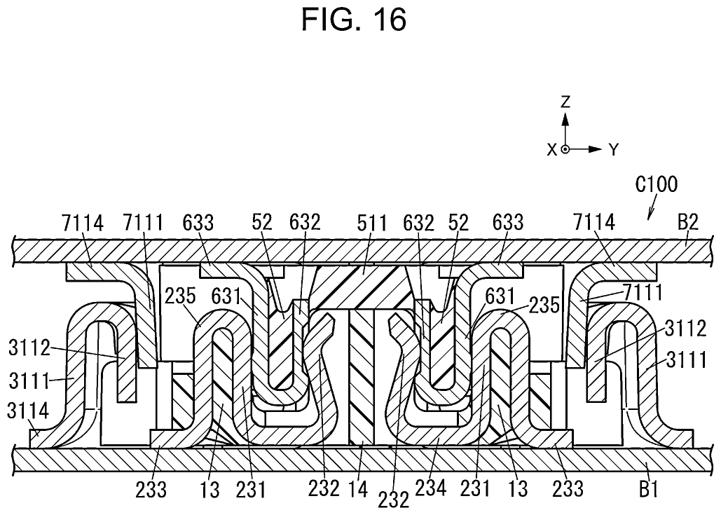

At the time of transition from the disconnected state to the connected state, as illustrated in FIGS. 15 and 16, fourth contact part 232 of connection terminal 23 is pressed by fourth mating contact part 632 of mating connection terminal 63, and thus, first coupling part 234 of connection terminal 23 is elastically deformed. As a result, fourth contact part 232 moves inward in the left-right direction. In the connected state, as illustrated in FIG. 16, third contact part 231 and fourth contact part 232 of connection terminal 23 come into contact with third mating contact part 631 and fourth mating contact part 632 of mating connection terminal 63, respectively, and thus, connection terminal 23 and mating connection terminal 63 are electrically connected. At this time, fourth contact point 2320 of fourth contact part 232 elastically comes into contact with fourth mating contact point 6320 of fourth mating contact part 632 by an elastic return force of first coupling part 234 to return to an original shape.

At the time of transition from the disconnected state to the connected state, as illustrated in FIGS. 12, 13, 15, and 16, first extension part 3112 and second extension part 3113 of first outer shield 311 come into contact with mating outer wall 7111 of first mating outer shield 711. At the time of transition from the disconnected state to the connected state, as illustrated in FIGS. 17 to 20, extension part 3122 of second outer shield 312 and mating outer wall 7121 of second mating outer shield 712 come into contact with each other. As a result, in the connected state, outer shield 31 and mating outer shield 71 are electrically connected.

At the time of from the disconnected state to the connected state, the pair of protrusions 322 of inner shield 32 and the pair of first mating protrusions 722 of mating inner shield 72 come into contact with each other. As a result, in the connected state, inner shield 32 and mating inner shield 72 are electrically connected.

Here, at the time of connecting connector C1 and mating connector C2, it is desirable that connector C1 and mating connector C2 are connected to each other in a state where connector C1 and mating connector C2 face each other (see FIGS. 12, 15, 17, and 19). However, connector set C100 may be a component having a very small length of about several [mm], and may be connected to each other in a state where mating connector C2 is inclined with respect to connector C1. When mating connector C2 approaches connector C1 in a state where mating connector C2 is inclined with respect to connector C1, for example, mating outer shield 71 of mating connector C2 comes into contact with first contact part 211 or second contact part 212 of first predetermined terminal 21 of connector C1, and a defect such as breakage of first contact part 211 or second contact part 212 may occur.

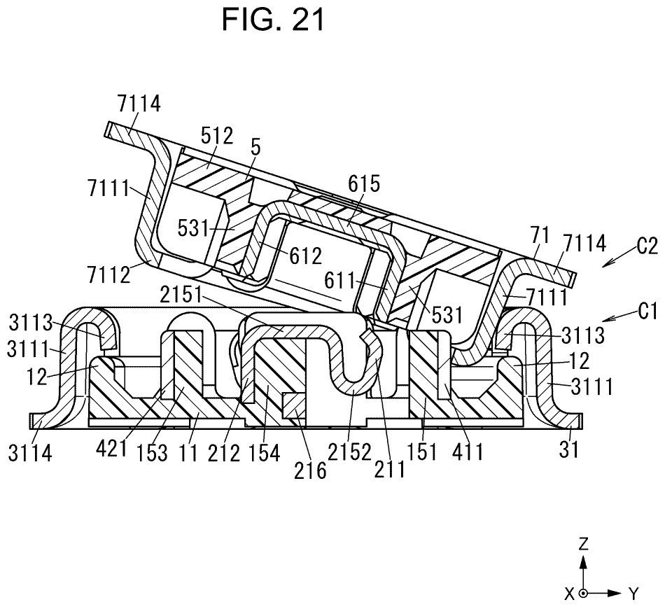

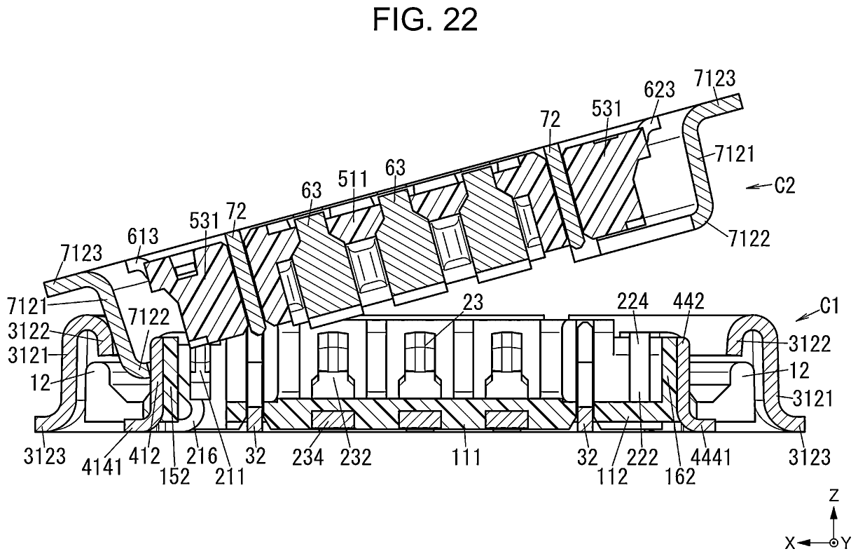

Here, in connector set C100 of the present exemplary embodiment, housing 1 of connector C1 includes first end wall part 15 having first partition wall 151, second partition wall 152, and third partition wall 153. Thus, even though mating connector C2 approaches connector C1 in a state of being inclined leftward as illustrated in FIG. 21, inclined rightward opposite to FIG. 21, or inclined forward as illustrated in FIG. 22, mating outer shield 71 is less likely to come into contact with first contact part 211 and second contact part 212. As a result, it is possible to suppress the occurrence of the defect such as breakage of first contact part 211 and second contact part 212 at the time of connection between connector C1 and mating connector C2.

In connector set C100 of the present exemplary embodiment, connector C1 includes guard 4 (first guard member 41 and second guard member 42) that covers at least a part of first end wall part 15. That is, at least a part of first end wall part 15 is covered and protected by guard 4. Thus, even though mating connector C2 approaches connector C1 in a state of being inclined leftward as illustrated in FIG. 21, inclined rightward opposite to FIG. 21, or inclined forward as illustrated in FIG. 22, for example, mating outer shield 71 is less likely to come into contact with first end wall part 15. As a result, it is possible to suppress the occurrence of the defect such as breakage of first end wall part 15 at the time of connection between connector C1 and mating connector C2. The occurrence of damage to first end wall part 15 is suppressed, and thus, the occurrence of the damage to the contact parts (first contact part 211 and second contact part 212) is also suppressed.

More specifically, guard 4 (first guard member 41) includes first site 411 disposed between first outer shield 311 and first predetermined terminal 21 and facing first outer shield 311 in the left-right direction. As a result, as illustrated in FIG. 21, even though mating connector C2 approaches connector C1 in a state of being inclined leftward, mating outer shield 71 is less likely to come into contact with first end wall part 15. Guard 4 (first guard member 41) has second site 412 facing second outer shield 312 in the front-rear direction. As a result, as illustrated in FIG. 22, even though mating connector C2 approaches connector C1 in a state of being inclined forward, mating outer shield 71 is less likely to come into contact with first end wall part 15. Guard 4 (first guard member 41) has corner site 413 connecting first site 411 and second site 412. As a result, even though mating connector C2 approaches connector C1 in an inclined state, mating outer shield 71 is less likely to come into contact with first end wall part 15. Guard 4 includes first guard member 41 and second guard member 42 that are disposed to be separated from each other in the left-right direction. As a result, even though mating connector C2 approaches connector C1 in a state of being inclined a side (right side) opposite to FIG. 21 in the left-right direction, mating outer shield 71 is less likely to come into contact with first end wall part 15.

In connector set C100 of the present exemplary embodiment, guard 4 (first guard member 41 or second guard member 42) is disposed between one of the pair of first outer shields 311 and first predetermined terminal 21 in the left-right direction. As a result, even though mating connector C2 approaches connector C1 in a state of being inclined leftward or rightward, since mating outer shield 71 comes into contact with guard 4 before first predetermined terminal 21 comes into contact with guard 4, mating outer shield 71 is less likely to come into contact with first predetermined terminal 21. As a result, it is possible to suppress the occurrence of the defect such as breakage of first predetermined terminal 21 at the time of connection between connector C1 and mating connector C2. Since mating outer shield 71 is less likely to come into contact with the contact parts (first contact part 221 and second contact part 222), it is possible to suppress the occurrence of the defect such as breakage of the contact part of first predetermined terminal 21.

In connector set C100 of the present exemplary embodiment, the front end of guard 4 (the front end of second site 412 of first guard member 41) is at the same position as the front end of first predetermined terminal 21 (the front end of proximity part 2162) in the front-rear direction. As a result, even though mating connector C2 approaches connector C1 in a state of being inclined forward, mating outer shield 71 comes into contact with first predetermined terminal 21 (proximity part 2162) or guard 4 before first end wall part 15 comes into contact with first predetermined terminal 21 or guard 4. Since mating outer shield 71 is less likely to come into contact with guard 4 before first predetermined terminal 21 comes into contact with guard 4, mating outer shield 71 is less likely to come into contact with first predetermined terminal 21. As a result, it is possible to suppress the occurrence of the defect such as breakage of first end wall part 15 and first predetermined terminal 21 at the time of connection between connector C1 and mating connector C2.

Note that the front end of guard 4 (the front end of second site 412 of first guard member 41) may be in front of the front end of first predetermined terminal 21 (the front end of the proximity part 2162) in the front-rear direction. As a result, even though mating connector C2 approaches connector C1 in a state of being inclined forward, mating outer shield 71 comes into contact with guard 4 before first predetermined terminal 21 comes into contact with guard 4. As a result, mating outer shield 71 is less likely to come into contact with the contact parts (first contact part 221 and second contact part 222) of first predetermined terminal 21. As a result, it is possible to suppress the occurrence of the defect such as breakage of first end wall part 15 and first predetermined terminal 21 at the time of connection between connector C1 and mating connector C2.

In connector set C100 of the present exemplary embodiment, guard 4 (first guard member 41) includes board connecting part 414. As a result, guard 4 can be firmly fixed to circuit board B1. Thus, the defect such as breakage of guard 4 and housing 1 when connector C1 and mating connector C2 are inserted and removed is suppressed.

In connector set C100 of the present exemplary embodiment, housing 1 includes second end wall part 16, and guard 4 includes third guard member 43 and fourth guard member 44. Thus, even though mating connector C2 approaches connector C1 in a state of being inclined rearward opposite to FIG. 22, mating outer shield 71 is less likely to come into contact with first contact part 221 and second contact part 222 of second predetermined terminal 22. As a result, it is possible to suppress the occurrence of the defect such as breakage of first contact part 221 and second contact part 222 at the time of connection between connector C1 and mating connector C2.

Note that in connector set C100 of the present exemplary embodiment, guard 4, first end wall part 15, and second end wall part 16 can also suppress the occurrence of the defect at the time of detaching mating connector C2 from connector C1.

In connector set C100 of the present exemplary embodiment, first predetermined terminal 21 has proximity part 2162 that covers a part (first end wall part 15) of housing 1 from the front side. As a result, even though mating connector C2 approaches connector C1 in a state of being inclined forward, mating outer shield 71 is less likely to come into contact with first contact part 211 and second contact part 212. As a result, it is possible to further suppress the occurrence of the defect at the time of connection between connector C1 and mating connector C2. The same applies to second predetermined terminal 22.

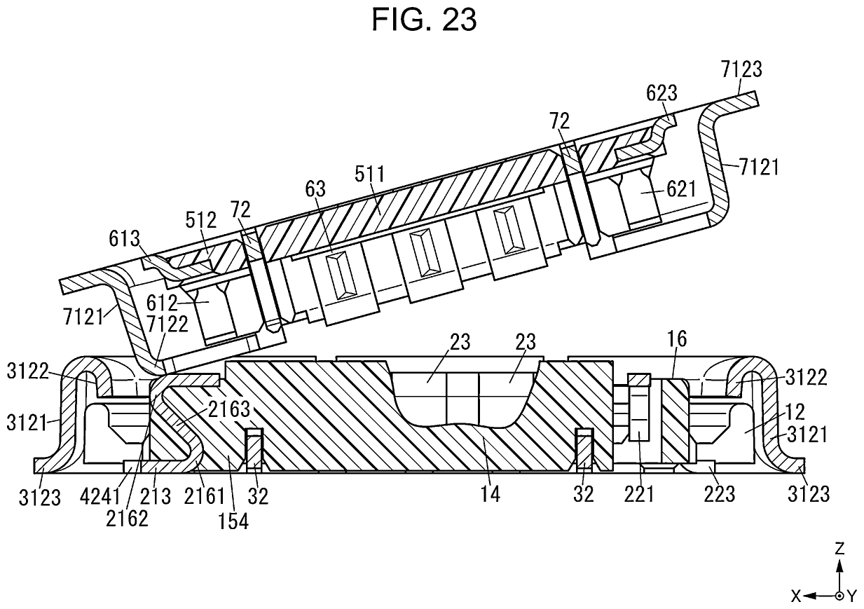

In connector set C100 of the present exemplary embodiment, first predetermined terminal 21 covers an upper surface of a part (first end wall part 15) of housing 1. As a result, as illustrated in FIG. 23, even though mating connector C2 approaches connector C1 in a state of being positioned relatively rearward, second mating outer shield 712 can be guided to void G1 between second outer shield 312 and first predetermined terminal 21 by moving second mating outer shield 712 forward while sliding an upper surface of first predetermined terminal 21. As a result, reliability of connection between connector C1 and mating connector C2 is improved. The same applies to second predetermined terminal 22.

### (1.5) Connected State

In the connected state where connector C1 and mating connector C2 are connected (see FIGS. 1, 11, 13, 16, 18, and 20), for example, relatively high-frequency signals can be transmitted between circuit board B1 and mating circuit board B2 via first predetermined terminal 21 and first mating predetermined terminal 61. Relatively high-frequency signals can be transmitted via second predetermined terminal 22 and second mating predetermined terminal 62. Relatively low-frequency signals can be transmitted via connection terminal 23 and mating connection terminal 63.

Here, in connector set C100 of the present exemplary embodiment, as illustrated in FIG. 14, in the connected state, two conduction paths, that is, the first path passing through first contact part 211 and first mating contact part 611 and the second path passing through second contact part 212 and second mating contact part 612 are formed between first predetermined terminal 21 and first mating predetermined terminal 61. As a result, even though conduction failure or the like occurs in one of the first path and the second path, conduction can be maintained in the other path. Thus, the reliability of conduction is improved. The same applies to second predetermined terminal 22 and second mating predetermined terminal 62.

In connector set C100 of the present exemplary embodiment, first contact part 211 is movable with respect to housing 1 and elastically comes into contact with first mating predetermined terminal 61. As a result, contact reliability between first predetermined terminal 21 and first mating predetermined terminal 61 is improved, and as a result, signal transmission performance is improved. In connector set C100 of the present exemplary embodiment, second contact part 212 is fixed to housing 1, and thus, the size of connector set C100 in the left-right direction in the connected state can be reduced as compared with a case where both the first contact part and the second contact part are movable. The same applies to second predetermined terminal 22.

In connector set C100 of the present exemplary embodiment, first contact part 211 and second contact part 212 of connector C1 are disposed between first mating contact part 611 and second mating contact part 612 of mating connector C2 in the connected state. In other words, first contact part 211 elastically comes into contact with first mating contact part 611 from an inside. As a result, contact reliability between first predetermined terminal 21 and first mating predetermined terminal 61 is improved as compared with a case where the first contact part elastically comes into contact with the first mating contact part from an outside, and as a result, signal transmission performance is improved. The size of connector set C100 in the connected state in the left-right direction can be reduced. The same applies to second predetermined terminal 22.

Note that in connector set C100 of the present exemplary embodiment, third mating contact part 631 and fourth mating contact part 632 of mating connector C2 are disposed between third contact part 231 and fourth contact part 232 of connector C1 in the connected state.

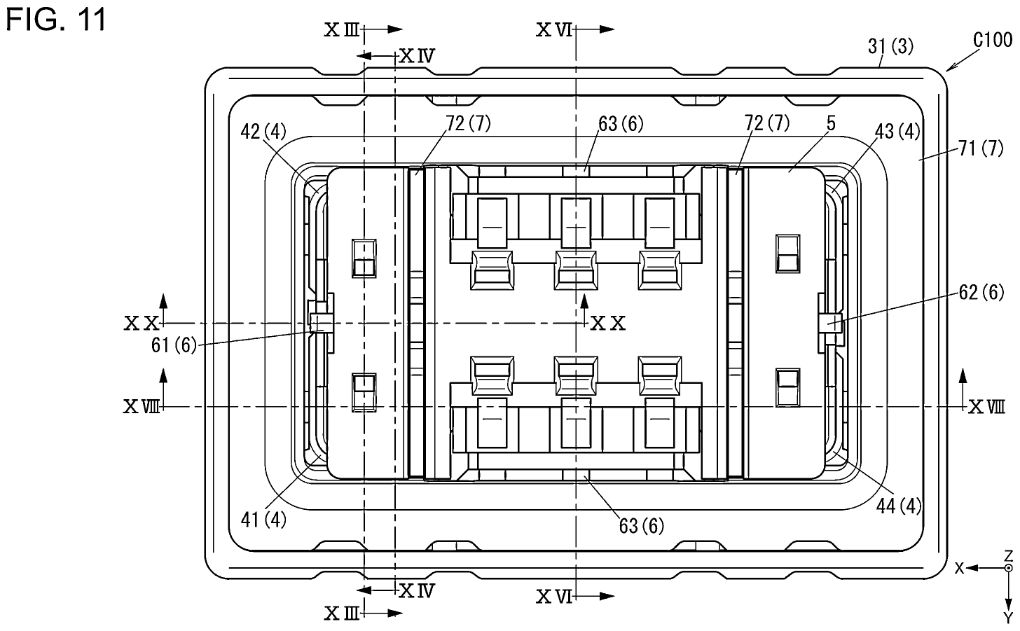

As illustrated in FIG. 11, in connector set C100 of the present exemplary embodiment, entire second mating outer shield 712 does not overlap mating housing 5 in the upper-lower direction. As a result, in the connected state, a resin member (housing or the like) is not present in regions between first predetermined terminal 21 and first mating predetermined terminal 61 and between second outer shield 312 and second mating outer shield 712 as viewed from the upper-lower direction, and a proportion occupied by an empty space increases. Thus, a capacitance of an electric path including first predetermined terminal 21 and first mating predetermined terminal 61 with respect to a ground (second outer shield 312 and second mating outer shield 712) can be reduced as compared with a case where the resin member is present. As a result, it is possible to improve signal transmission performance in a case where a high-frequency signal is transmitted via an electric path including the first predetermined terminal and the first mating predetermined terminal. The same applies to second predetermined terminal 22 and second mating predetermined terminal 62.

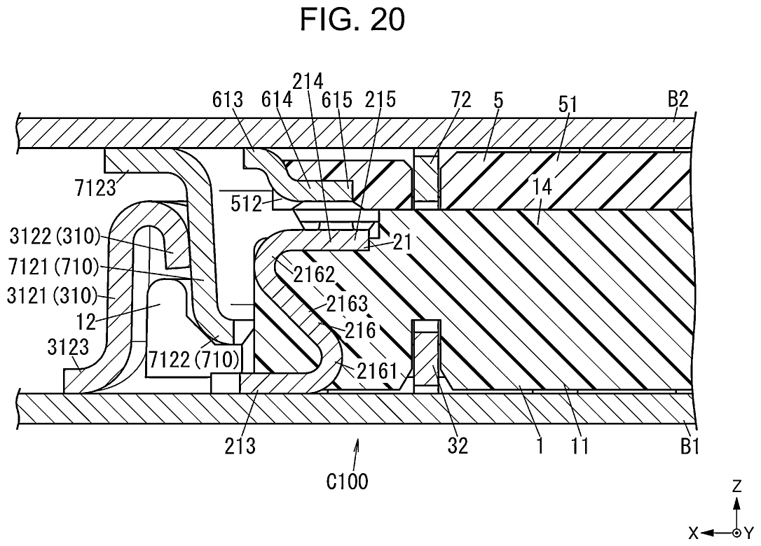

In connector set C100 of the present exemplary embodiment, first predetermined terminal 21 has separation part 2161 separated from side wall 310 of outer shield 31 in the front-rear direction. As a result, a shortest distance between first predetermined terminal 21 and the ground (outer shield 31) increases, and the capacitance of the electric path including first predetermined terminal 21 with respect to a ground (outer shield 31) decreases. As a result, signal transmission performance is improved in a case where a high-frequency signal is transmitted via the electric path including the first predetermined terminal. In particular, as illustrated in FIG. 20, in the connected state, a distance between first predetermined terminal 21, outer shield 31, and mating outer shield 71 and a distance between first predetermined terminal 21, inner shield 32, and mating inner shield 72 may be approximately the same. The same applies to second predetermined terminal 22.

As illustrated in FIG. 20, in the connected state, mating side wall 710 of mating shield 7 (mating outer wall 7121 and mating extension part 7122 of second mating outer shield 712 on the front side) is positioned in front of first predetermined terminal 21 and is separated from first predetermined terminal 21. In the connected state, separation part 2161 of first predetermined terminal 21 is further separated from mating side wall 710 than proximity part 2162. As a result, signal transmission performance is improved in a case where a high-frequency signal is transmitted via the electric path including the first predetermined terminal. The same applies to second predetermined terminal 22.

In connector set C100 of the present exemplary embodiment, since first guard member 41 and second guard member 42 are separate bodies, an area of guard 4 facing outer shield 31 can be reduced as compared with a case where the first guard member and the second guard member are connected, and signal transmission performance can be improved. The same applies to third guard member 43 and fourth guard member 44.

In connector set C100 of the present exemplary embodiment, guard 4 (first guard member 41 to fourth guard member 44) does not come into contact with shield 3 and mating shield 7 in the connected state. As described above, guard 4 (first guard member 41 to fourth guard member 44) is electrically insulated from mating shield 7 in the connected state. As a result, it is possible to prevent guard 4 from coming into contact with mating shield 7 and being at the same potential as shield 3 in the connected state between connector C1 and the mating connector C2. As a result, it is possible to improve signal transmission performance in a case where a high-frequency signal is transmitted via an electric path including first predetermined terminal 21 and first mating predetermined terminal 61.

In connector set C100 of the present exemplary embodiment, guard 4 does not overlap mating shield 7 in the upper-lower direction in the connected state. As a result, it is possible to prevent guard 4 from coming into contact with mating shield 7 and being at the same potential as shield 3 in the connected state between connector C1 and the mating connector C2. As a result, it is possible to improve signal transmission performance in a case where a high-frequency signal is transmitted via an electric path including first predetermined terminal 21 and first mating predetermined terminal 61.

### (2) Modifications

The exemplary embodiment described above is merely one of various exemplary embodiments of the present disclosure. The exemplary embodiment described above can be variously changed according to a design and the like as long as the object of the present disclosure can be achieved. Hereinafter, modifications of the exemplary embodiment will be listed. The exemplary embodiment described above and the modifications to be described below can be applied in appropriate combination. In the following description of each modification, the description of the same configuration as the above exemplary embodiment may be appropriately omitted.

In one modification, at least a part of at least one of first guard member 41 to fourth guard member 44 may be made of resin. The resin as the materials of first guard member 41 to fourth guard member 44 is desirably higher in strength than the resin as the material of housing 1. In a case where first guard member 41 to fourth guard member 44 are made of resin, first guard member 41 to fourth guard member 44 may be integrally formed with housing 1 by two-color molding. In a case where first guard member 41 to fourth guard member 44 are made of resin, these members may come into contact with terminal 2.

In one modification, guard 4 may include at least one of first guard member 41 to fourth guard member 44.

In one modification, first guard member 41 may have at least one of first site 411 and second site 412. The same applies to second guard member 42 to fourth guard member 44.

In one modification, connector C1 may include a metal fitting instead of outer shield 31. The metal fitting may be electrically insulated from the ground and the plurality of terminals 2. The metal fitting may be used as a power supply terminal.

In one modification, mating connector C2 may include a mating metal fitting instead of mating outer shield 71. The mating metal fitting may be electrically insulated from the ground and the plurality of mating terminals 6. The mating metal fitting may be used as a power supply terminal.

In one modification, outer shield 31 does not necessarily need to seamlessly surround the plurality of terminals 2 in the circumferential direction, and may be divided with a gap in the circumferential direction. The same applies to mating outer shield 71.

In one modification, intermediate part 2163 may not extend obliquely forward and upward from separation part 2161, and may have, for example, a shape in which a portion extending linearly in the upper-lower direction and a portion extending linearly in the front-rear direction are connected in side view, for example, an L-shape.

### (3) Aspects

As is apparent from the above-described exemplary embodiment and modifications, the following aspects are disclosed in the present specification.

Connector (C1) of a first aspect is mounted on circuit board (B1) and connected to mating connector (C2). Connector (C1) includes a plurality of terminals (2), housing (1), and shield (3). The plurality of terminals (2) include a predetermined terminal (first predetermined terminal 21) disposed on a foremost side in a front-rear direction. Housing (1) holds the plurality of terminals (2). Shield (3) is held by housing (1). Shield (3) surrounds the predetermined terminal. Shield (3) has side wall (310) positioned in front of the predetermined terminal. Mating connector (C2) includes a plurality of mating terminals (6). Each of the plurality of terminals (2) of connector (C1) is electrically connected to one corresponding mating terminal of the plurality of mating terminals (6). The plurality of mating terminals (6) include a mating predetermined terminal (first mating predetermined terminal 61) electrically connected to the predetermined terminal. The predetermined terminal includes a contact part (first contact part 211 or second contact part 212), board connecting part (213), and coupling part (214). The contact part includes a contact (first contact point 2110 or second contact point 2120) that comes into contact with the mating predetermined terminal. Board connecting part (213) is configured to be connected to circuit board (B1). Coupling part (214) couples the contact part and board connecting part (213). Coupling part (214) includes separation part (2161) and proximity part (2162). Separation part (2161) is separated from side wall (310) of shield (3) in the front-rear direction. Separation part (2161) is coupled to a rear end of board connecting part (213). Proximity part (2162) is coupled to separation part (2161). Proximity part (2162) is disposed closer to side wall (310) of shield (3) than separation part (2161). Proximity part (2162) faces side wall (310) of shield (3) via void (G1). Proximity part (2162) covers a part (first end wall part 15) of housing (1) from a front side. In the front-rear direction, a distance between side wall (310) of shield (3) and the contact part is larger than a distance between side wall (310) of shield (3) and proximity part (2162).

According to this aspect, the predetermined terminal (first predetermined terminal 21) has separation part (2161), and thus, a capacitance of an electric path including the predetermined terminal with respect to ground (shield 3) decreases. As a result, signal transmission performance is improved in a case where a signal is transmitted via the electric path including the predetermined terminal. According to this aspect, since the predetermined terminal has proximity part (2162) that covers a part (first end wall part 15) of housing (1) from the front side, even though mating connector (C2) approaches connector (C1) in a state of being inclined forward, a member (mating outer shield 71 or the like) included in mating connector (C2) is less likely to come into contact with housing (1). As a result, it is possible to suppress the occurrence of the defect such as breakage of housing (1) at the time of connection between connector (C1) and mating connector (C2).

In connector (C1) of a second aspect, in the first aspect, separation part (2161) and proximity part (2162) constitute a conduction path between board connecting part (213) and the contact part (first contact part 211 or second contact part 212).

According to this aspect, signal transmission performance can be improved.

In connector (C1) of a third aspect, in the second aspect, coupling part (214) further includes intermediate part (2163) that couples separation part (2161) and proximity part (2162) and constitutes a part of the conduction path. The intermediate part extends obliquely forward and upward from separation part (2161) to be coupled to proximity part (2162).

According to this aspect, a length of a conduction path between separation part (2161) and proximity part (2162) can be minimized. As a result, signal transmission performance is improved in a case where a signal is transmitted via the electric path including the predetermined terminal (first predetermined terminal 21).

In connector (C1) of a fourth aspect, in any one aspect of the first to third aspects, coupling part (214) further includes intermediate part (2163) that couples separation part (2161) and proximity part (2162). Intermediate part (2163) is buried in housing (1).

According to this aspect, the deformation of the predetermined terminal (first predetermined terminal 21) is prevented.

In connector (C1) of a fifth aspect, in any one aspect of the first to fourth aspects, separation part (2161) is buried in housing (1).

According to this aspect, the deformation of the predetermined terminal (first predetermined terminal 21) is prevented.

In connector (C1) of a sixth aspect, in any one aspect of the first to fifth aspects, the predetermined terminal (first predetermined terminal 21) includes first contact part (211) and second contact part (212) arranged in a left-right direction. Each of first contact part (211) and second contact part (212) is the contact part. Coupling part (214) has flat part (2151) coupled to first contact part (211) and second contact part (212). Flat part (2151) includes flat face (2150) extending in the left-right direction. Flat face (2150) is exposed upward from housing (1).

According to this aspect, a probe can be brought into contact with flat face (2150), and conduction between circuit board (B1) and the predetermined terminal (first predetermined terminal 21) can be easily confirmed.

In connector (C1) according to a seventh aspect, in any one aspect of the first to sixth aspects, the predetermined terminal (first predetermined terminal 21) includes first contact part (211) and second contact part (212) aligned in the left-right direction. Each of first contact part (211) and second contact part (212) is the contact part. Coupling part (214) includes first coupling part (215) that couples first contact part (211) and second contact part (212), and second coupling part (216) that couples first coupling part (215) and board connecting part (213).

According to this aspect, signal transmission performance can be improved.

In connector (C1) according to an eighth aspect, in the seventh aspect, second coupling part (216) is positioned between first contact part (211) and second contact part (212) in the left-right direction.

According to this aspect, signal transmission performance can be improved.

In any one aspect of the first to eighth aspects, connector (C1) of a ninth aspect further includes guard (4). Guard (4) is held by housing (1) and is electrically insulated from shield (3) and the plurality of terminals (2). In the front-rear direction, a front end of guard (4) is at the same position as a front end of proximity part (2162) of the predetermined terminal (first predetermined terminal 21) or in front of a front end of proximity part (2162) of the predetermined terminal.

According to this aspect, when connector (C1) and mating connector (C2) are connected, a member (the mating outer shield (71) or the like) included in mating connector (C2) is less likely to come into contact with the predetermined terminal (first predetermined terminal 21). As a result, it is possible to suppress the occurrence of the defect such as breakage of housing (1) at the time of connection between connector (C1) and mating connector (C2).

Connector (C1) of a tenth aspect is connected to mating connector (C2). Connector (C1) includes a predetermined terminal (first predetermined terminal 21) and housing (1). Housing (1) holds a predetermined terminal. Mating connector (C2) includes a mating predetermined terminal (first mating predetermined terminal 61) electrically connected to the predetermined terminal. The predetermined terminal includes first contact part (211), second contact part (212), board connecting part (213), and coupling part (214). First contact part (211) includes first contact point (2110) that comes into contact with the mating predetermined terminal. Second contact part (212) includes second contact point (2120) that comes into contact with a mating predetermined terminal. Board connecting part (213) is configured to be connected to circuit board (B1). Coupling part (214) couples first contact part (211), second contact part (212), and board connecting part (213). Coupling part (214) is elastically deformable such that first contact part (211) moves in the left-right direction in which first contact part (211) and second contact part (212) are disposed to be aligned. Second contact part (2112) is fixed to housing (1). First contact point (2110) is disposed on a surface of first contact part (211) opposite to a facing surface facing second contact part (212). Second contact point (2120) is disposed on a surface of second contact part (212) opposite to a facing surface facing first contact part (211).

According to this aspect, first contact part (211) elastically comes into contact with the mating predetermined terminal (first mating predetermined terminal) from an inside in the left-right direction. As a result, contact reliability between the predetermined terminal (first predetermined terminal 21) and the mating predetermined terminal is improved, and as a result, signal transmission performance is improved. A size of connector (C1) in the left-right direction can be reduced.

In connector (C1) according to an eleventh aspect, in the tenth aspect, coupling part (214) has flat part (2151) including flat face (2150) extending in the left-right direction. Flat face (2150) is exposed upward from housing (1).

According to this aspect, a probe can be brought into contact with flat face (2150), and conduction between circuit board (B1) and the predetermined terminal (21) can be easily confirmed.

In connector (C1) according to a twelfth aspect, in the tenth or eleventh aspect, coupling part (214) includes a curved part (first curved part 2152). The curved part is coupled to first contact part (211). The curved part is curved to protrude downward.

According to this aspect, since the curved part (first curved part 2152) has a U shape, a dimension in the left-right direction can be reduced, and an elastic force when the curved part is elastically deformed is improved. As a result, contact reliability between first contact part (211) and the mating predetermined terminal (first mating predetermined terminal 61) is improved, and signal transmission performance is improved.

In any one aspect of the tenth to twelfth aspects, connector (C1) of a thirteenth aspect further includes connection terminal (23) held by housing (1). Mating connector (C2) further includes mating connection terminal (63) electrically connected to connection terminal (23). Connection terminal (23) includes third contact part (231) and fourth contact part (232). Third contact part (231) includes third contact point (2310) that comes into contact with the mating connection terminal. Fourth contact part (232) includes fourth contact point (2320) that comes into contact with the mating connection terminal. Fourth contact part (232) faces third contact part (231). Third contact point (2310) is disposed on a facing surface of third contact part (231) facing fourth contact part (232). Fourth contact point (2320) is disposed on a facing surface of fourth contact part (232) facing third contact part (231).

According to this aspect, signal transmission performance can be improved.

In any one aspect of the tenth to thirteenth aspects, connector (C1) of a fourteenth aspect further includes shield (3). Shield (3) is held by housing (1). Shield (3) surrounds the predetermined terminal (first predetermined terminal 21).

According to this aspect, electromagnetic shielding properties are improved.

In connector (C1) of a fifteenth aspect, in the fourteenth aspect, housing (1) has bottom wall (11) and outer wall (12) protruding upward from a peripheral edge of bottom wall (11). Shield (3) has outer wall (3111 or 3121) and extension part (second extension part 3113 or extension part 3122). The outer wall is disposed outward with respect to outer wall (12). The extension part is curved inward from an upper end of the outer wall and extends downward. A lowermost end of the extension part overlaps an uppermost end of outer wall (12) of housing (1) in the upper-lower direction via gap (G10).

According to this aspect, signal transmission performance can be improved.

In any one aspect of the tenth to fifteenth aspects, connector (C1) of a sixteenth aspect further includes a plurality of terminals (2) held by housing (1), shield (3) held by housing (1), first guard member (41), and second guard member (42). The plurality of terminals (2) include a predetermined terminal. First guard member (41) and second guard member (42) are held by housing (1). First guard member (41) and second guard member (42) are electrically insulated from shield (3) and the plurality of terminals (2). First guard member (41) and second guard member (42) are disposed to be separated from each other in the left-right direction. In the left-right direction, first contact part (211) and second contact part (212) are disposed between first guard member (41) and second guard member (42).

According to this aspect, even though mating connector (C2) approaches connector (C1) in a state of being inclined in the left-right direction, a member (the mating outer shield (71) or the like) included in mating connector (C2) is less likely to come into contact with first contact part (211) and second contact part (212). As a result, it is possible to suppress the occurrence of the defect such as breakage of first contact part (211) and second contact part (212) at the time of connecting connector (C1) and mating connector (C2).

Connector set (C100) according to a seventeenth aspect includes connector (C1) according to any one aspect of the tenth to sixteenth aspects and mating connector (C2). A mating predetermined terminal (first mating predetermined terminal 61) includes first mating contact part (611), second mating contact part (612), mating board connecting part (613), and mating coupling part (614). First mating contact part (611) is fixed to mating housing (5). First mating contact part (611) contacts first contact part (211). Second mating contact part (612) is fixed to mating housing (5). Second mating contact part (612) contacts second contact part (212). Mating board connecting part (613) is configured to be connected to mating circuit board (B2). Mating coupling part (614) couples first mating contact part (611), second mating contact part (612), and mating board connecting part (613). In a connected state where connector (C1) and mating connector (C2) are connected, first contact part (211) and second contact part (212) of connector (C1) are disposed between first mating contact part (611) and second mating contact part (612).

According to this aspect, first contact part (211) elastically comes into contact with the mating predetermined terminal (first mating predetermined terminal 61) from the inside in the left-right direction. As a result, contact reliability between the predetermined terminal (first predetermined terminal 21) and the mating predetermined terminal is improved, and as a result, signal transmission performance is improved.

In connector set (C100) according to an eighteenth aspect, in the seventeenth aspect, mating housing (5) has a pair of mating partial wall parts (531) that comes into contact with first mating contact part (611) and second mating contact part (612), respectively, outside first mating contact part (611) and second mating contact part (612) in the left-right direction. A position of second mating contact part (612) with respect to mating coupling part (614) in the connected state is a position outside in the left-right direction from a position of second mating contact part (612) with respect to mating coupling part (614) in the disconnected state where connector (C1) and mating connector (C2) are not connected.

According to this aspect, second mating contact part (612) and mating housing (5) are deformed, and thus, it is possible to suppress the occurrence of the defect such as breakage of the mating predetermined terminal (first mating predetermined terminal 61).

What is claimed is:

1. A connector mounted on a circuit board and connected to a mating connector, the connector comprising:
a plurality of terminals including a predetermined terminal disposed on a foremost side in a front-rear direction;
a housing that holds the plurality of terminals; and
a shield that is held by the housing, surrounds the predetermined terminal, and has a side wall positioned in front of the predetermined terminal,
wherein
the mating connector includes a plurality of mating terminals including a mating predetermined terminal electrically connected to the predetermined terminal,
each of the plurality of terminals of the connector is electrically connected to one corresponding mating terminal of the plurality of mating terminals,
the predetermined terminal includes
a contact part including a contact point that comes into contact with the mating predetermined terminal,
a board connecting part configured to be connected to the circuit board, and
a coupling part that couples the contact part and the board connecting part,
the coupling part includes
a separation part separated from the side wall of the shield in the front-rear direction and coupled to a rear end of the board connecting part, and
a proximity part coupled to the separation part, disposed closer to the side wall of the shield than the separation part, facing the side wall of the shield via a void, and covering a part of the housing from a front side, and
a distance between the side wall of the shield and the contact part is larger than a distance between the side wall of the shield and the proximity part in the front-rear direction.

2. The connector according to claim 1, wherein the separation part and the proximity part constitute a conduction path between the board connecting part and the contact part.

3. The connector according to claim 2, wherein
the coupling part further includes an intermediate part that couples the separation part and the proximity part to constitute a part of the conduction path, and
the intermediate part extends obliquely forward and upward from the separation part to be coupled to the proximity part.

4. The connector according to claim 1, wherein
the coupling part further includes an intermediate part that couples the separation part and the proximity part, and
the intermediate part is buried in the housing.

5. The connector according to claim 1, wherein the separation part is buried in the housing.

6. The connector according to claim 1,
wherein the predetermined terminal includes a first contact part and a second contact part aligned in a left-right direction, and each of the first contact part and the second contact part is the contact part,
the coupling part includes a flat part that includes a flat face extending in the left-right direction and is coupled to the first contact part and the second contact part, and
the flat face is exposed upward from the housing.

7. The connector according to claim 1, wherein
the predetermined terminal includes a first contact part and a second contact part aligned in a left-right direction, and each of the first contact part and the second contact part is the contact part, and
the coupling part includes
a first coupling part that couples the first contact part and the second contact part, and
a second coupling part that couples the first coupling part and the board connecting part.

8. The connector according to claim 7, wherein the second coupling part is positioned between the first contact part and the second contact part in the left-right direction.

9. The connector according to claim 1, further comprising a guard held by the housing and electrically insulated from the shield and the plurality of terminals,
wherein, in the front-rear direction, a front end of the guard is at a same position as a front end of the proximity part of the predetermined terminal, or is in front of the front end of the proximity part of the predetermined terminal.

10. A connector connected to a mating connector, comprising:
a predetermined terminal; and
a housing that holds the predetermined terminal,
wherein
the mating connector includes a mating predetermined terminal electrically connected to the predetermined terminal,
the predetermined terminal includes
a first contact part including a first contact point that comes into contact with the mating predetermined terminal,
a second contact part including a second contact point that comes into contact with the mating predetermined terminal,
a board connecting part configured to be connected to a circuit board, and
a coupling part that couples the first contact part, the second contact part, and the board connecting part,
the coupling part is configured to be elastically deformable such that the first contact part moves in the left-right direction in which the first contact part and the second contact part are aligned,
the second contact part is fixed to the housing,
the first contact point is disposed on a surface of the first contact part opposite to a facing surface facing the second contact part, and
the second contact point is disposed on a surface of the second contact part opposite to a facing surface facing the first contact part.

11. The connector according to claim 10, wherein
the coupling part includes a flat part including a flat face extending in the left- right direction, and
the flat face is exposed upward from the housing.

12. The connector according to claim 10, wherein the coupling part includes a curved part coupled to the first contact part and curved to protrude downward.

13. The connector according to claim 10, further comprising a connection terminal held by the housing,
wherein
the mating connector further includes a mating connection terminal electrically connected to the connection terminal,
the connection terminal includes
a third contact part including a third contact point that comes inti contact with the mating connection terminal, and
a fourth contact part that includes a fourth contact point that comes into contact with the mating connection terminal and faces the third contact part,
the third contact point is disposed on a facing surface of the third contact part facing the fourth contact part, and
the fourth contact point is disposed on a facing surface of the fourth contact part facing the third contact part.

14. The connector according to claim 10, further comprising a shield that is held by the housing and surrounds the predetermined terminal.

15. The connector according to claim 14, wherein
the housing includes a bottom wall and an outer wall protruding upward from a peripheral edge of the bottom wall,
the shield includes
an outer wall disposed outward with respect to the outer wall, and
an extension part curved inward from an upper end of the outer wall and extending downward, and
a lowermost end of the extension part overlaps an uppermost end of the outer wall of the housing in an upper-lower direction via a gap.

16. The connector according to claim 10, further comprising:
a plurality of terminals held by the housing;
a shield held by the housing;
a first guard member held by the housing and electrically insulated from a shield and a plurality of terminals; and
a second guard member held by the housing and electrically insulated from the shield and the plurality of terminals,
wherein
the plurality of terminals include the predetermined terminal,
the first guard member and the second guard member are disposed to be separated from each other in the left-right direction, and
the first contact part and the second contact part are disposed between the first guard member and the second guard member in the left-right direction.

17. A connector set comprising:
the connector according to claim 10; and
the mating connector,
wherein
the mating predetermined terminal includes
a first mating contact part fixed to a mating housing and coming into contact with the first contact part,
a second mating contact part fixed to the mating housing and coming into contact with the second contact part,
a mating board connecting part configured to be connected to a mating circuit board, and
a mating coupling part that couples the first mating contact part, the second mating contact part, and the mating board connecting part, and
in a connected state where the connector and the mating connector are connected, the first contact part and the second contact part of the connector are disposed between the first mating contact part and the second mating contact part.

18. The connector set according to claim 17, wherein
the mating housing includes
a first mating partial wall part that comes into contact with the first mating contact part on an outer side of the first mating contact part and the second mating contact part in the left-right direction, and
a second mating partial wall part that comes into contact with the second mating contact part on an outer side of the first mating contact part and the second mating contact part in the left-right direction, and
the second mating contact part with respect to the mating coupling part in the connected state is positioned outward in the left-right direction from the second mating contact part with respect to the mating coupling part in a disconnected state where the connector and the mating connector are not connected.
